(19) United States
(12) Patent Application Publication
(10) Pub. No.: US 2026/0334546 A1
(43) Pub. Date: Oct. 29, 2026

(54) AEROSOL GENERATING DEVICE WITH MODULAR HOUSING CONCEPT

(71) Applicant: Philip Morris Products S.A., Neuchatel (CH)

(72) Inventors: Sander BROUWER, Lausanne (CH); Semen GURALEVYCH, Lausanne (CH)

(73) Assignee: Philip Morris Products S.A., Neuchatel (CH)

(21) Appl. No.: 19/139,660

(22) PCT Filed: Nov. 20, 2023
(86) PCT No.: PCT/EP2023/082335

§ 371 Date: Jun. 16, 2025

(30) Foreign Application Priority Data
Dec. 30, 2022 (EP) 22217415

(51) Int. Cl. A24F 40/42; A24F 40/60; A24F 40/70; A24F 40/95; H02J 7/70

(52) U.S. Cl. CPC A24F 40/42; A24F 40/60; A24F 40/70; A24F 40/95; H02J 7/70

(57) ABSTRACT

An aerosol-generating device is provided, including: first and second housing portions being reversibly interconnectable and selectively arranged in an attached state or detached state; a power-consuming component; a power-supply component to supply power to the power-consuming component in the attached state, the first housing portion including the power-consuming component, and the second housing portion including the power-supply component; and a cushioning mechanism to cushion the housing portions relative to each other in the attached state, one of the housing portions including a male cushioning element and the other one including a female cushioning element, the male and female cushioning elements are mutually engaged with each other in the attached state so as to elastically preload the housing portions relative to each other, the male cushioning element has a form of a pad, knob, or elongated element, the male cushioning element including an elastic material, and the elastic material including rubber.

### CROSS-REFERENCE TO RELATED APPLICATIONS

Each of the following PCT Patent applications is hereby incorporated by reference herein in its respective entirety:
1. PCT Patent Application No. PCT/EP 2022/057230, entitled “Aerosol-generating device comprising Cover Element with Cavity”.

### TECHNICAL FIELD

The present invention relates to an aerosol-generating device, comprising a power-consuming unit, configured to consume power during operation of the aerosol-generating device to generate an aerosol, and a power-supply unit, configured to supply power to the power-consuming unit.

### BACKGROUND

One type of aerosol-generating system is an electrically operated smoking system. Known handheld electrically operated smoking systems typically comprise an aerosol-generating device comprising a rechargeable battery, control electronics and an electric heater for heating an aerosol-generating article designed specifically for use with the aerosol-generating device. In some examples, the aerosol-generating article comprises an aerosol-forming substrate, such as a tobacco rod or a tobacco plug, and the heater contained within the aerosol-generating device is inserted into or located around the aerosol-forming substrate when the aerosol-generating article is inserted into the aerosol-generating device. In an alternative electrically operated smoking system, the aerosol-generating article may comprise a capsule containing an aerosol-forming substrate, such as loose tobacco.

In known electrically operated smoking systems the batteries are inseparably integrated into or connected to a housing of the aerosol-generating device or are installed in such a way that they can only be removed from same with relative high effort. As a consequence, users intend to throw away the entire aerosol-generating device, including the battery, as soon as the battery has reached the end of life, even though the device as such would still be functional, which on the one hand creates unnecessary waste and on the other hand makes it difficult to recycle the materials used in the batteries, such as mercury or cadmium.

It would be desirable to provide an aerosol-generating device that minimizes the waste associated with ageing batteries for operating the aerosol generating device, thus contributing to the protection, preservation and improvement of the quality of the environment.

### SUMMARY

According to a first aspect of the invention, there is provided an aerosol-generating device, comprising: a first housing portion and a second housing portion, the first and second housing portions being reversibly interconnectable and configured to be selectively arranged in any one of at least two different states, including an attached state, in which the housing portions are attached to each other, and a detached state, in which the housing portions are detached from each other, a power-consuming unit, configured to consume power during operation of the aerosol-generating device to generate an aerosol, a power-supply unit, configured to supply power to wherein the first housing portion includes the power-consuming unit, and wherein the second housing portion includes the power-supply unit. The separability of the power supply unit from the power consuming-unit allows easy replacement of the power supply unit, so that the lifetime of the aerosol-generating device in no longer limited to the lifetime or capacity of the battery. In addition, different power supply units having different battery capacities can be provided, to allow for a modular power supply design where a user can choose a different battery power supply unit depending on how much electric power capacity the user wants.

Preferred embodiments are subject of the subclaims. Preferred features are disclosed below:

### Housing Portions

The first and second housing portions may be mechanically and electrically coupled with each other in the attached state.

The first and second housing portions may be mechanically and electrically decoupled from each other in the detached state.

The first and second housing portions may be reusable.

The first and second housing portions may be configured to be repeatedly arranged in any one of the at least two different states multiple times.

The first housing portion may comprise an aerosol-generating article receiving cavity for removably receiving an aerosol-generating article.

The first and second housing portions may be interconnected between the attached state and the detached state and vice versa by manual operation in a tool-free manner.

The first housing portion may include a heater module.

The second housing portion may include a battery module.

### Power-Consuming Unit

The power-consuming unit may comprise a heater for heating the aerosol or a product used for generating the aerosol.

The heater may be an induction coil.

The heater may be an electrical resistance heating means, or other type of heating means.

The aerosol-generating device may further comprise a controller configured to control a consumption of power by the heater, in the attached state of the housing.

The power-consuming unit may comprise an aerosol-generating chamber.

The power-consuming unit may be removable from the first housing portion.

The power-consuming unit may only be removed from the first housing portion in the detached state of the housing portions.

### Power-Supply Unit

The power-supply unit may comprise at least one battery, preferably at least one single-use battery or rechargeable battery, or a battery holder for such battery.

The battery may be a standard-type battery, preferably one more more batteries of the size or 21700.

The battery may be removably attached to the power-supply unit.

The power-supply unit may be removable from the second housing portion.

The power-supply unit may only be removed from the second housing portion in the detached state of the housing portions.

An opening of the second housing portion for removing the power-supply unit from the second housing portion may be covered by the first housing portion in the attached state.

The second housing portion may comprise a cavity for accommodation of the power-supply unit and a lid for closing the cavity.

The power-supply unit may be hermetically sealed within the second housing portion.

### Shape and Structure of the Housing

A separation line or separation plane between the housing portions may extend along one of the main axes of the device, preferably a longitudinal axis, in the attached state of the housing portions.

Each of the housing portions may extend along one of the main axes of the device, preferably a longitudinal axis, in the attached state of the housing portions.

The housing portions in the attached state together may form a housing of the aerosol-generating device.

The housing may be shaped as an oval cylinder.

The housing may be shaped as a cuboid with rounded edges.

The housing may extend along a longitudinal axis.

The housing may comprise a top end and a bottom end intersecting the longitudinal axis.

The housing may comprise at least one side wall extending from the top end to the bottom end and surrounding the longitudinal axis.

The sidewall may be free of corners and/or edges between the top end and the bottom end of the housing.

At least two side surfaces of the side wall may be parallel to each other and/or parallel to the longitudinal axis.

The housing portions may be firmly connected relative to each other in the attached state.

The housing portions may be elastically preloaded relative to each other in the attached state so as to prevent rattling or wobbling between the housing portions.

At least one of the first and second housing portions may be partially or fully made from plastic, in particular ABS.

At least one of the first and second housing portions may be partially or fully made from or coated by a metal, in particular aluminum or an aluminum alloy.

At least one of the first and second housing portions may have a matte surface finish.

The first housing portion may have a different color and/or surface finish as compared to the second housing portion.

The first housing portion may have protruding element protruding towards the second housing portion in the attached state.

The protruding element may laterally protrude from a main longitudinal body of the first housing portion at a side of the longitudinal body where the aerosol-generating article receiving cavity is arranged.

The protruding element may form a mating surface of the first housing portion.

The protruding element may protrude beyond a mating surface of the first housing portion.

The protruding element may be fully accommodated into a corresponding cavity/opening of the second housing portion in the attached state of the housing portions, for example such that an outer edge of the first housing portion and an outer edge of the second housing portion that are facing each other in the attached state are arranged to form a substantially straight line.

The protruding element may be located between two electric terminals of the first housing portion for electrically connecting the first housing portion to the second housing portion.

The terminals of the first housing portion next to the protruding element may be male electric terminals and configured to be electrically connected to female electric terminals of the second housing portion.

The second housing portion may have protruding element protruding towards the first housing portion in the attached state.

The protruding element may laterally protrude from a main longitudinal body of the second housing portion at a bottom end thereof.

The protruding element may form a mating surface of the second housing portion.

The protruding element may protrude beyond a mating surface of the second housing portion.

The protruding element may be fully accommodated into a corresponding cavity/opening of the first housing portion in the attached state of the housing portions, for example such that an outer edge of the first housing portion and an outer edge of the second housing portion that are facing each other in the attached state are arranged to form a substantially straight line.

The protruding element may be located between two electric terminals of the second housing portion for electrically connecting the second housing portion to the first housing portion.

The terminals of the second housing portion next to the protruding element may be male electric terminals and configured to be electrically connected to female electric terminals of the first housing portion.

### Generation of Signal and Detection of Trigger Event

The device may be configured to detect a trigger event and to generate a visual and/or acoustic and/or haptic signal upon detection of the trigger event.

The device may be configured to detect a position or state of the housing portions or a change of position or change of state of the housing portions as a trigger event, preferably the event of entering into the attached and/or a locked state.

The device may be configured to detect a user operation as a trigger event, preferably a push of a button, in particular a release-button, such as a release-button to detach the housing portions or a main activation unit to activate generation of an aerosol.

The device may be configured to detect the presence of at least one of the first and second housing portions, the power-consuming unit and the power-supply unit by means of a authentication key in an attached state of the housing portions as the trigger event.

### Intermediate State of Housing Portions

The first and second housing portions may be configured to be selectively arranged in any one of at least three different states, including the attached state, the detached state as well as an intermediate state, in which the housing portions are mechanically movably coupled relative to each other and electrically decoupled from each other.

The use of the intermediate state may enable a user to establish a small and difficult-to-hit electrical connection between the housing portions via a guiding and easy-to-create mechanical connection. Therefore, the assembly process may be faster and wear of the electrical contacts can be reduced, thereby increasing lifetime of the housing portions. Said “guiding” within the intermediate state may be implemented via one or more of the guide mechanism, the shape of the mating surfaces of the housing portions, and the cushioning mechanism as described below.

The housing portions may define a fulcrum in the intermediate state, wherein the housing portions can be pivoted relative to each other about the fulcrum from a spread configuration into an abutted configuration.

The housing portions may be configured to be detached from each other by pivoting the housing portions in the intermediate state relative to each other about the fulcrum from the abutted configuration into the spread configuration, and subsequently decoupling the housing portions from each other.

For transfer from the detached state into the attached state and/or for transfer from the attached state into the detached state, the housing portions may have to enter into the intermediate state.

### Guide Mechanism for Relative Movement of Housing Portions

The device may comprise a guide mechanism for guiding a movement of the housing portions relative to each other.

The guide mechanism may be configured to guide the movement of the housing portions relative to each other in the intermediate state.

The guide mechanism may be configured to guide a movement of the housing portions relative to each other along a predetermined trajectory.

The guide mechanism may be configured to guide at least one translatory and/or rotary movement of the housing portions relative to each other, preferably along and/or about at least one of the device's main axes.

The guide mechanism may be configured to guide a movement of the housing portions relative to each other along a linear and/or circular and/or curved path.

The guide mechanism may comprise male and female guide elements, configured to engage with each other for enabling the guided movement. The male guide element may be provided on one of the first and second housing portions. The female guide element may be provided on another one of the first and second housing portions.

The male guide element may be a guide pin or rail.

The female guide element may be a guide groove.

The guide mechanism may further comprises a stopper, limiting the guided movement of the housing portions relative to each other in a predetermined position.

The stopper may be provided on one of the first and second housing portions and configured to abut another one of the first and second housing portions in the attached state.

### Mating Surfaces of Housing Portions

Each of the housing portions may comprise at least one mating surface, wherein the mating surfaces are configured to mutually face and/or engage with each other in attached state.

The first and second housing portions may comprise a male mating surface and another one of the first and second housing portions may comprise a female mating surface.

The male mating surface element may have a shape that is negative to a shape of the female mating surface element.

The male mating surface may have a convex shape and the female mating surface has a concave shape.

The male mating surface may extend from the top end and/or bottom end of one of the first and second housing portions, wherein the female mating surface may extend from the top end and/or bottom end of the respective other one of the first and second housing portions.

Each of the mating surfaces may be adjacent to at least one side surface of the respective housing portion, wherein the side surfaces of the housing portions are flush with each other in the attached state.

The mating surfaces may be adjacent to and located between two side surfaces on opposite sides of the respective housing portion, wherein two pairs of two side surfaces of the housing portions on opposite sides of the housing portions are flush with each other in the attached state.

The mating surfaces may be located between two parallel mating surface edges.

The male and female mating surfaces may comprise a male guide element of a guide mechanism of the device, wherein the other one of the male and female mating surfaces comprises a female guide element of the guide mechanism.

A height of the male mating surface may be within a range from 40% to 100%, preferably from 60% to 98%, in particular from 70% to 85% of the respective housing portion.

A width of the male mating surface may be within a range from 60% to 100%, preferably from 80% to 98%, in particular from 85% to 95% of a width of the respective housing portion.

Between 40% to 100%, preferably from 60% to 98%, in particular from 70% to 85% of area of the mating surface may extend in parallel to a longitudinal axis of the aerosol-generating device.

### Cushioning Element

The device may comprise a cushioning mechanism configured to cushion the housing portions relative to each other in the attached state.

At least one of the first and second housing portions may comprise a male cushioning element and the other one of the first and second housing portions comprises a female cushioning element, wherein the male and female cushioning elements are mutually engaged with each other in the attached state so as to elastically preload the housing portions relative to each other.

At least one of the cushioning elements may be removably attached to the respective housing portion.

At least one of the cushioning elements may form or cover a lid for covering an opening of the respective housing portion, in particular an opening for removing a power-supply unit or power-consuming unit from the respective housing portion.

The lid may be attached by a screw mount.

The male cushioning element may be embodied as a snap-fit protrusion configured to snap-fit into a corresponding recess of the female cushioning element.

The male cushioning element may be configured to expand into the female cushioning element upon entering into the attached state of the housing portions.

Each of the male and female cushioning elements may be symmetrical with respect to a longitudinal direction and/or a transversal direction of the aerosol-generating device.

The male cushioning element may have a form of a pad, knob or elongated element.

The male cushioning element and the female cushioning element may have the same size.

The aerosol-generating device may comprise multiple cushioning elements.

The male and female cushioning elements may engage by a form-fit connection.

At least one of the male and female cushioning elements may comprise an elastic material.

The elastic material comprises rubber.

At least one of the male and female cushioning elements may be configured to be displaced by the other one of the male and female cushioning elements prior to entering into engagement.

Each of the male and female cushioning elements may be provided on the respective mating surface of the respective housing portion.

### Reversible Locking Mechanism

The device may comprise a reversible locking mechanism configured to reversibly lock the housing portions relative to each other in the attached state of the housing.

The reversible locking mechanism may enable a safe connection and prevent inadvertent separation of the housing portions in the attached state.

The reversible locking mechanism may be configured to be reversibly arranged in any one of a locked state, in which the housing portions are locked relative to each other in the attached state of the housing portions, and an unlocked state, in which the housing portions are unlocked relative to each other.

The locking mechanism may comprise a self-locking mechanism configured to self-lock the housing portions upon entering into the attached state.

The locking mechanism may comprise at least one male locking element provided on one of the first and second housing portions and at least one female locking element provided on the other one of the first and second housing portions.

The male and female locking elements may be to configured to mutually engage with each other for locking the housing portions.

The male and female locking elements may be to configured to disengage from each other for unlocking the housing portions.

At least one of the male and female locking elements may be mechanically and/or elastically preloaded into an engagement position.

The male and female locking elements may be configured to engage with each other according to hook-and-eye principle.

The male and female locking elements may be configured to establish a mechanical and/or electrical connection between the first and second housing portions.

The reversible locking mechanism may comprise at least one snap fit connection.

The snap fit connection may comprise a mechanical retention mechanism for mechanical.

The snap fit connection may comprise electric terminals for electric interconnection of the first and second housing portions.

The reversible locking mechanism may comprise two snap fit connectors, arranged at opposite ends of the first and second housing portions.

### Actuator for Locking Mechanism

The locking mechanism may comprise an actuator, configured to lock or unlock the locking mechanism upon actuation.

The actuator may comprise a push-button.

The locking mechanism may comprise at least one active locking member provided on one of the first and second housing portions and at least one passive locking member provided on another one of the first and second housing portions, wherein the actuation of the actuator may cause the active locking member to move.

The actuation of the actuator may cause the active locking member to engage the passive locking member for locking the locking mechanism.

The actuation of the actuator may cause the active locking member to disengage the passive locking member for unlocking the locking mechanism.

The actuation of the actuator may require push/pull/slide/rotation operation by a user.

The push button may be provided on the bottom end or side wall of the device.

The push button may form at least 75% of a surface of the bottom end.

### Closure Mechanism for Aerosol-Generating Article-Receiving Cavity

The aerosol-generating device may comprise an aerosol-generating article-receiving cavity for receiving an aerosol-generating article, wherein the device may further comprise a closure mechanism configured to be selectively arranged in each one of at least two different states, including an open state, in which the aerosol-generating article receiving cavity is at least partially or fully exposed, and a closed state, in which the aerosol-generating article receiving cavity is fully closed.

The closure mechanism may prevent dirt from entering into the aerosol-generating article receiving cavity in the closed state, thus ensuring proper aerosol-generation without dirt particles obstructing the heating of the aerosol-generating article.

The first housing portion may comprise the aerosol-generating article receiving cavity.

The opening communicates with an aerosol-generating chamber of the aerosol-generating device.

The opening may be positioned at the top end of the device.

The closure mechanism may be configured to be transferred between the open state and the closed state by manual/finger operation, preferably by push/pull operation.

The closure mechanism may be removably attached to at least one of the first and second housing portions.

The closure mechanism may be attached to at least one of the first and second housing portions by a bayonet mount.

The closure mechanism may be mechanically and/or magnetically attached to at least one of the first and second housing portions.

The closure mechanism may be attached to a protruding element of the first housing portion protruding towards the second housing portion in the attached state.

The closure mechanism may be configured to be arranged in the closed state even in the detached state of the housing portions.

The closure mechanism may be mechanically and/or magnetically held in the open state and/or into the closed state.

The closure mechanism may be configured to seal the opening in the closed state, preferably in an airtight or hermetical manner.

The closure mechanism may comprise an attachment base that is (removably) attached to at least one of the first and second housing portions and a cover that is configured to change its position and/or shape relative to the attachment base for transferring the closure mechanism between the open state and the closed state.

### Movable Cover

The closure mechanism may comprise a guide for guiding the movement of the cover relative to the attachment base between the open and the closed state.

One of the cover and the attachment base may comprise a male guide element such as a guide pin, wherein the other one of the cover and the attachment base comprises a female guide element such as a guide pin.

The attachment base may be removably attached to the protruding element of the first housing portion by screw joint, bayonet joint or other rotatable element.

A torque engaging surface of the screw or rotatable element may be arranged at a lower/inner surface of the protruding element.

One of the male and female guide elements may be provided on the protruding element of the first housing portion.

The cover may be configured to be moved relative to the attachment base between the open state and the closed state along a linear and/or circular and/or curved path.

The attachment base may have the shape of a pillar.

The attachment base may be invisible from the outside in the attached state of the housing portions and in the closed state of the closure mechanism.

The attachment base may be attachable to and/or detachable from at least one of the first and second housing portions.

The closure mechanism may be detachable in a detached state of the housing portions.

The device has a closed outer surface in the attached state of the housing portions and the closed state of the closure mechanism.

The closure mechanism comprises a cover that may be configured to change its shape for transferring the closure mechanism between the open state and the closed state.

The cover may be attached to the second housing portion.

### Foldable Cover

The cover may be a foldable cover, which is configured to fold and unfold for transferring the closure mechanism between the open state and the closed state.

The cover may be at least partially made from an elastic material.

The cover may comprise at least two pivotably/foldably connected segments.

The segments may be integrally formed.

The segments may be connected by means of a solid joint.

The segments may be configured to angle/abut against each other in the open state

The segments may be configured to be aligned/flush with each other in the closed state.

The closed state of the closure mechanism, a separation line between the two segments may be aligned with a separation line or plane of the housing portions in the attached state.

The closed state of the closure mechanism, a perimeter of each of the segments may be aligned with a perimeter of the housing portions.

One of the segments comprises a protrusion which may be configured to enter into the opening in the closed state of the closure mechanism.

Each of the segments may be adapted to cover the top end of one of the housing portions in the closed state of the closure mechanism.

A color and/or material of each of the segments may be adapted to a color and/or material of the housing portion covered at its top end by the respective segment in the closed state of the closure mechanism.

### Various Aspects of the Cover

The cover may be made from metal and/or plastic.

The cover may comprise a metal coating.

The cover may be made from at least two different materials.

The cover may have an elastic body (silicon, or silicon-like body).

The cover may comprise a metal or metal-like coating.

The metal coating of the cover may extend on an outer surface of the cover to form an end edge that aligns with the outer side edges of the first housing portion.

The metal coating may comprise at least one magnetic material.

The magnetic material may comprise at least one of iron, nickel and cobalt.

The closure mechanism may comprise a cover that is movable between the open state and the closed state.

The cover may be attached to the second housing portion.

The cover may be configured to slide relative to the housing between the open state and the closed state along a linear and/or circular and/or curved path.

The cover may have an oval shape.

The cover may have two parallel outer edges.

The direction of movement of the cover may be parallel to its parallel outer edges.

The cover has two convexly shaped outer edges on opposite ends thereof.

The direction of movement of the cover may be aligned with its main axis.

The cover may be movable in a plane perpendicular to a main axis of the device, in particular the longitudinal axis of the device.

The device may comprise a guide for guiding the movement of the cover between the open state and the closed state.

At least one of the first and second housing portions may define a frame that partially or fully surrounds the cover in the open state and/or the closed state.

The frame partially or fully may surround the cover in the plane of its extension.

The frame partially or fully may surround the cover in its direction of movement between the open state and the closed state.

The frame may be provided on the protruding element of the first housing portion that laterally protrudes from the main longitudinal body of the first housing portion.

### Electrical Connection Between Power-Supply Unit and Power-Consuming Unit

The device may comprise an electrical connection for electrically connecting the power-supply unit to the power-consuming unit in the attached state of the housing portions, wherein the electrical connection comprises a first electrical contact provided on the first housing portion and a second electrical contact provided on the second housing portion, wherein the first and second electrical contacts are elastically preloaded against each other in the attached state.

At least one of the first and second electrical contacts may comprise a spring-loaded element.

The spring-loaded element may be at least one of a pin, sphere, or a ball.

The pin may be a pogo pin.

At least one of the first and second electrical contacts may comprise a recess for receiving the spring-loaded element or a terminal.

The terminal may be a contact plate.

The recess may comprise a spring-loaded metal tab configured to engage with the pin.

Each of the first and second electrical contacts may be provided on the respective mating surface of the respective housing portion.

### Charge Indicator

The device may further comprise a charge indicator indicating a charge amount of the power-supply unit.

The charge indicator may comprise an electronic display.

The charge indicator display may be on the power supply unit.

The electronic display may be at least one of a segmented display, a LED display, or a OLED display.

The charge indicator may further comprise a charge indicator activator positioned on one of the first and second housing portions, and configured to activate the charge indicator.

The charge indicator activator may be a push-button or a touch display.

A button to activate the charge indicator display may be not visible in the attached state of the housing portions.

A button to activate the charge indicator display may be provided on a mating surface of the second housing portion.

The charge indicator may further comprise a controller configured to control the electronic display upon user interaction via the charge indicator activator to show the state of charge of the power-supply unit.

### Replacement Battery Module

The aerosol-generating device may further comprise a replacement battery module configured to be removably attached to the first housing portion instead of the second housing portion, wherein the replacement battery module accommodates a second power-supply unit that is configured to supply power to the power consuming unit in the attached state.

The second power-supply unit may have a second electrical charge storage capacity that is different to a storage capacity of the power-supply unit accommodated within the first housing portion.

A ratio of the storage capacity of the first and second power supply units may be between 1.5 and 3, preferably between 1.5 and 2.5, in particular between 1.7 and 2.3.

The replacement battery module may have identical interfaces for electrical and/or mechanical connection to the first housing portion as compared to the second housing portion.

### Identification Item and Unit

At least one of the first and second housing portions, the power-consuming unit and the power-supply unit may comprise an identification item, wherein the device comprises an identification unit for identifying at least one of the first and second housing portions, the power-consuming unit and the power-supply unit by means of the identification item.

The identification item may comprise an authenticator key, for example a secret and concealed authentication key

The identification item may be unique, allowing unique identification of the housing portion or unit equipped with the unique identification item.

The identification unit may comprise a communication interface enabling communication between at least two of the first and second housing portions, the power-consuming unit and the power-supply unit for identification.

The communication interface may be at least one of a wireless communication interface or a contact-based interface.

The identification item may be permanently embedded.

The identification item may be at least one of an embedded-SIM (eSIM) or integrated SIM (iSIM).

The device may be configured to admit power supply from the power-supply unit to the power-consuming unit upon successful identification of the power-consuming unit and the power-supply unit.

### Charging Module

The aerosol-generating device may further comprise a charging module configured to be removably attached to the second housing portion instead of the first housing portion, wherein the charging module is configured to charge the power-supply unit in the attached state.

The power-supply unit may comprise a rechargeable power supply and a charging circuit positioned within the housing portion accommodating the power-supply unit and configured to control a supply of power received from an external device for recharging the power supply.

The power-supply unit may comprise a rechargeable battery.

The battery may comprise a lithium-based battery.

The power-supply unit may comprise a charging electrical contact positioned on the housing portion accommodating the power-supply unit for receiving a supply of power from an external device for recharging the power supply.

The charging electrical contact may comprise the second electrical contact of the electrical connection and/or wherein the charging electrical contact forms part of a USB-A connector, a USB-B connector, a USB-C connector, or a micro-USB connector.

The charging circuit may comprise a wireless charging circuit configured to wirelessly receive a supply of power from an external device for recharging the power supply.

The charging module may have identical interfaces for electrical and/or mechanical connection to the second housing portion as compared to the first housing portion.

### Method for Assembling the Aerosol-Generating Device

According to a second aspect of the invention, there is provided a method for assembling the aerosol-generating device according to any one of the preceding examples, comprising the steps of transferring the housing portions from the detached state, in which the housing portions are both electrically and mechanically decoupled, into an intermediate state, in which the housing portions are electrically decoupled from each other and mechanically movably coupled relative to each other, and moving the housing portions relative to each other in the intermediate state until entering into the attached state, in which the housing portions are both electrically and mechanically coupled with each other.

### LIST OF EXAMPLES

The invention is defined in the claims. However, below there is provided a non-exhaustive list of non-limiting examples. Any one or more of the features of these examples may be combined with any one or more features of another example, embodiment, or aspect described herein.

### Removable Battery Aspects

Example ExI: An aerosol-generating device, comprising:
a first housing portion and a second housing portion, the first and second housing portions being reversibly interconnectable and configured to be selectively arranged in any one of at least two different states, including an attached state, in which the housing portions are attached to each other, and a detached state, in which the housing portions are detached from each other,
a power-consuming unit, configured to consume power during operation of the aerosol-generating device to generate an aerosol,
a power-supply unit, configured to supply power to the power-consuming unit in the attached state of the housing portions,
wherein the first housing portion includes the power-consuming unit, and
wherein the second housing portion includes the power-supply unit.

Example ExI1: An aerosol-generating device according to Example ExI, wherein the first and second housing portions are mechanically and electrically coupled with each other in the attached state.

Example ExI2: An aerosol-generating device according to any one of Examples ExI or ExI1, wherein the first and second housing portions are mechanically and electrically decoupled from each other in the detached state.

Example ExI3: An aerosol-generating device according to any one of Examples ExI to ExI2, wherein the first and second housing portions are reusable.

Example ExI4: An aerosol-generating device according to any one of Examples ExI to ExI3, wherein the first and second housing portions are configured to be repeatedly arranged in any one of the at least two different states multiple times.

Example ExI5: An aerosol-generating device according to any one of Examples ExI to ExI4, wherein the first housing portion comprises an aerosol-generating article receiving cavity for removably receiving an aerosol-generating article.

Example ExI6: An aerosol-generating device according to any one of Examples ExI to ExI5, wherein the first and second housing portions can be interconnected between the attached state and the detached state and vice versa by manual operation in a tool-free manner.

Example ExI7: An aerosol-generating device according to any one of Examples ExI to ExI6, wherein the first housing portion includes a heater module.

Example ExI8: An aerosol-generating device according to any one of Examples ExI to ExI7, wherein the second housing portion includes a battery module.

Example ExI9: An aerosol-generating device according to any one of Examples ExI to ExI8, wherein the power-consuming unit comprises a heater for heating the aerosol or a product used for generating the aerosol.

Example ExI9a: An aerosol-generating device according to Example ExI9, wherein the heater is an induction coil.

Example ExI9b: An aerosol-generating device according to any one of Examples ExI9 or ExI9a, wherein the heater is an electrical resistance heating means.

Example ExI10: An aerosol-generating device according to any one of Examples ExI to ExI9, wherein the device further comprises a controller configured to control a consumption of power by the heater, in the attached state of the housing.

Example ExI11: An aerosol-generating device according to any one of Examples ExI to ExI10, wherein the power-consuming unit comprises an aerosol-generating chamber.

Example ExI12: An aerosol-generating device according to any one of Examples ExI to ExI11 wherein the power-consuming unit is removable from the first housing portion.

Example ExI12a: An aerosol-generating device according to Example ExI12, wherein the power-consuming unit can only be removed from the first housing portion in the detached state of the housing portions.

Example ExI13: An aerosol-generating device according to any one of Examples ExI to ExI12a, wherein the power-supply unit comprises at least one battery, preferably at least one single-use battery or rechargeable battery, or a battery holder for such battery.

Example ExI13a: An aerosol-generating device according to Example ExI13, wherein the at least one battery is a standard-type battery, preferably a battery of the size 18650 or 21700.

Example ExI13b: An aerosol-generating device according to Example ExI13 or ExI3a, wherein the battery is removably attached to the power-supply unit.

Example ExI14: An aerosol-generating device according to any one of Examples ExI to ExI13b, wherein the power-supply unit is removable from the second housing portion.

Example ExI14a: An aerosol-generating device according to Example ExI14, wherein the power-supply unit can only be removed from the second housing portion in the detached state of the housing portions.

Example ExI14b: An aerosol-generating device according to any one of Examples ExI14 or ExI14a, wherein an opening of the second housing portion for removing the power-supply unit from the second housing portion is covered by the first housing portion in the attached state.

Example ExI15: An aerosol-generating device according to any one of Examples ExI to ExI14b, wherein second housing portion comprises a cavity for accommodation of the power-supply unit and a lid for closing the cavity.

Example ExI16: An aerosol-generating device according to any one of Examples ExI to ExI15, wherein the power-supply unit is hermetically sealed within the second housing portion.

Example ExI17: An aerosol-generating device according to any one of Examples ExI to ExI16, wherein a separation line or separation plane between the housing portions extends along one of the main axes of the device, preferably a longitudinal axis, in the attached state of the housing portions.

Example ExI18: An aerosol-generating device according to any one of Examples ExI to ExI17, wherein each of the housing portions extends along one of the main axes of the device, preferably a longitudinal axis, in the attached state of the housing portions.

Example ExI19: An aerosol-generating device according to any one of Examples ExI to ExI18, wherein the housing portions in the attached state together form a housing of the aerosol-generating device.

Example ExI19a: An aerosol-generating device according to Example ExI19, wherein the housing is shaped as an oval cylinder

Example ExI19b: An aerosol-generating device according to to any one of Examples ExI19 or ExI19a, wherein the housing is shaped as a cuboid with rounded edges.

Example ExI19c: An aerosol-generating device according to any one of Examples ExI19 to ExI 19b, wherein the housing extends along a longitudinal axis

Example ExI19ci: An aerosol-generating device according to Example ExI19c, wherein the housing comprises a top end and a bottom end intersecting the longitudinal axis

Example ExI19cii: An aerosol-generating device according to any one of Examples ExI19c to ExI9ci, wherein the housing comprises at least one side wall extending from the top end to the bottom end and surrounding the longitudinal axis.

Example ExI19ciia: An aerosol-generating device according to the preceding Example, wherein the sidewall is free of corners and/or edges between the top end and the bottom end of the housing.

Example ExI19ciii: An aerosol-generating device according to any one of Examples ExI19c to ExI9ciia, wherein least two side surfaces of the side wall are parallel to each other and/or parallel to the longitudinal axis.

Example ExI20: An aerosol-generating device according to any one of Examples ExI to ExI19, wherein the housing portions are firmly connected relative to each other in the attached state.

Example ExI21: An aerosol-generating device according to any one of Examples ExI to ExI20, wherein the housing portions are elastically preloaded relative to each other in the attached state so as to prevent rattling or wobbling between the housing portions.

Example ExI22: An aerosol-generating device according to any one of Examples ExI to ExI21, wherein the device is configured to detect a trigger event and to generate a visual and/or acoustic and/or haptic signal upon detection of the trigger event.

Example ExI22a: An aerosol-generating device according to the preceding Example, wherein the device is configured to detect a position or state of the housing portions or a change of position or change of state of the housing portions as a trigger event, preferably the event of entering into the attached and/or a locked state.

Example ExI22b: An aerosol-generating device according to any one of Examples ExI22 to ExI22a, wherein the device is configured to detect a user operation as a trigger event, preferably a push of a button, in particular a release-button, such as a release-button to detach the housing portions or a main activation unit to activate generation of an aerosol.

Example ExI22c: An aerosol-generating device according to any one of Examples ExI22 to ExI22b, wherein the device is configured to detect the presence of at least one of the first and second housing portions, the power-consuming unit and the power-supply unit by means of a authentication key in an attached state of the housing portions as the trigger event.

Example ExI23: An aerosol-generating device according to any one of Examples ExI to ExI22, wherein at least one of the first and second housing portions is partially or fully made from plastic, in particular ABS.

Example ExI24: An aerosol-generating device according to any one of Examples ExI to ExI23, wherein at least one of the first and second housing portions is partially or fully made from metal, in particular aluminum.

Example ExI25: An aerosol-generating device according to any one of Examples ExI to ExI24, wherein at least one of the first and second housing portions has a matte surface finish.

Example ExI26: An aerosol-generating device according to any one of Examples ExI to ExI25, wherein the first housing portion has a different color and/or surface finish as compared to the second housing portion.

Example ExI27: An aerosol-generating device according to any one of Examples ExI to ExI26, wherein the first housing portion has protruding element protruding towards the second housing portion in the attached state.

Example ExI27a: An aerosol-generating device according to the preceding Example, wherein the protruding element laterally protrudes from a main longitudinal body of the first housing portion at a side of the longitudinal body where the aerosol-generating article receiving cavity is arranged.

Example ExI27b: An aerosol-generating device according to any one of Examples ExI27 or ExI27a, wherein the protruding element forms a mating surface of the first housing portion.

Example ExI27c: An aerosol-generating device according to any one of Examples ExI27 to ExI27b, wherein the protruding element protrudes beyond a mating surface of the first housing portion.

Example ExI27d: An aerosol-generating device according to any one of Examples ExI27 to ExI27c, wherein the protruding element is fully accommodated in a corresponding cavity/opening of the second housing portion in the attached state of the housing portions, for example such that a outer edge of the first housing portion and an outer edge of the second housing portion that are facing each other in the attached state are arranged to form a substantially straight line.

Example ExI27e: An aerosol-generating device according to any one of Examples ExI27 to ExI27d, wherein the protruding element is located between two electric terminals of the first housing portion for electrically connecting the first housing portion to the second housing portion.

Example ExI27ei: An aerosol-generating device according to the preceding Example, wherein the terminals of the first housing portion next to the protruding element are male electric terminals and configured to be electrically connected to female electric terminals of the second housing portion.

Example ExI28: An aerosol-generating device according to any one of Examples ExI to ExI27e, wherein the second housing portion has protruding element protruding towards the first housing portion in the attached state.

Example ExI28a: An aerosol-generating device according to Example ExI28, wherein the protruding element laterally protrudes from a main longitudinal body of the second housing portion at a bottom end thereof.

Example ExI28b: An aerosol-generating device according to any one of Examples ExI28 to ExI28a, wherein the protruding element forms a mating surface of the second housing portion.

Example ExI28c: An aerosol-generating device according to any one of Examples ExI28 to ExI28b, wherein the protruding element protrudes beyond a mating surface of the second housing portion.

Example ExI28d: An aerosol-generating device according to any one of Examples ExI28 to ExI28c, wherein the protruding element is fully accommodated in a corresponding cavity/opening of the first housing portion in the attached state of the housing portions, for example such that a outer edge of the first housing portion and an outer edge of the second housing portion that are facing each other in the attached state are arranged to form a substantially straight line.

Example ExI28e: An aerosol-generating device according to any one of Examples ExI28 to ExI28d, wherein the protruding element is located between two electric terminals of the second housing portion for electrically connecting the second housing portion to the first housing portion.

Example ExI28ei: An aerosol-generating device according to the preceding Example, wherein the terminals of the second housing portion next to the protruding element are male electric terminals and configured to be electrically connected to female electric terminals of the first housing portion.

### Intermediate State

Example ExII: An aerosol-generating device according to any one of the preceding Examples, wherein the first and second housing portions are configured to be selectively arranged in any one of at least three different states, including the attached state, the detached state as well as an intermediate state, in which the housing portions are mechanically movably coupled relative to each other and electrically decoupled from each other.

Example ExII1: An aerosol-generating device according to Example ExII, wherein the housing portions define a fulcrum in the intermediate state, wherein the housing portions can be pivoted relative to each other about the fulcrum from a spread configuration into an abutted configuration.

Example ExII2: An aerosol-generating device according to any one of Examples ExII to ExII1, wherein the housing portions are configured to be detached from each other by pivoting the housing portions in the intermediate state relative to each other about the fulcrum from the abutted configuration into the spread configuration, and subsequently decoupling the housing portions from each other.

Example ExII3: An aerosol-generating device according to any one of Examples ExII to ExII2, wherein, for transfer from the detached state into the attached state and/or for transfer from the attached state into the detached state, the housing portions must enter into the intermediate state.

### Guide Mechanism

Example ExIII: An aerosol-generating device according to any one of the preceding Examples, wherein the device comprises a guide mechanism for guiding a movement of the housing portions relative to each other.

Example ExIII1: An aerosol-generating device according to Example ExIII, wherein the guide mechanism is configured to guide the movement of the housing portions relative to each other in the intermediate state.

Example ExIII2: An aerosol-generating device according to any one of Examples ExIII to ExIII1, wherein the guide mechanism is configured to guide a movement of the housing portions relative to each other along a predetermined trajectory.

Example ExIII3: An aerosol-generating device according to any one of Examples ExIII to ExIII2, wherein the guide mechanism is configured to guide at least one translatory and/or rotary movement of the housing portions relative to each other, preferably along and/or about at least one of the device's main axes.

Example ExIII4: An aerosol-generating device according to any one of Examples ExIII to ExIII3, wherein the guide mechanism is configured to guide a movement of the housing portions relative to each other along a linear and/or circular and/or curved path.

Example ExIII5: An aerosol-generating device according to any one of Examples ExIII to ExIII4, wherein the guide mechanism comprises male and female guide elements, configured to engage with each other for enabling the guided movement, wherein the male guide element is provided on one of the first and second housing portions, wherein the female guide element is provided on another one of the first and second housing portions.

Example ExIII5a: An aerosol-generating device according to Example ExIII5, wherein the male guide element is a guide pin or rail

Example ExIII5b: An aerosol-generating device according to any one of Examples ExIII5 to ExIII5a, wherein the female guide element is a guide groove.

Example ExIII6: An aerosol-generating device according to any one of Examples ExIII to ExIII5, wherein the guide mechanism further comprises a stopper, limiting the guided movement of the housing portions relative to each other in a predetermined position.

Example ExIII6a: An aerosol-generating device according to Example ExIII6, wherein the stopper is provided on one of the first and second housing portions and configured to abut another one of the first and second housing portions in the attached state.

### Mating Surfaces

Example ExIV: An aerosol-generating device according to any one of the preceding Examples, wherein each of the housing portions comprises at least one mating surface, wherein the mating surfaces are configured to mutually face and/or engage with each other in attached state.

Example ExIV1: An aerosol-generating device according to Example ExIV, wherein one of the first and second housing portions comprises a male mating surface and another one of the first and second housing portions comprises a female mating surface.

Example ExIV1a: An aerosol-generating device according to Examples ExIV1, wherein the male mating surface element has a shape that is negative to a shape of the female mating surface element.

Example ExIV1b: An aerosol-generating device according to any one of Examples ExIV1 to ExIV1a, Wherein the male mating surface has a convex shape and the female mating surface has a concave shape.

Example ExIV1c: An aerosol-generating device according to any one of Examples ExIV1 to ExIV1b, wherein the male mating surface extends from the top end and/or bottom end of one of the first and second housing portions, wherein the female mating surface extends from the top end and/or bottom end of the respective other one of the first and second housing portions.

Example ExIV2: An aerosol-generating device according to any one of Examples ExIV to ExIV1c, wherein each of the mating surfaces is adjacent to at least one side surface of the respective housing portion, wherein the side surfaces of the housing portions are flush with each other in the attached state.

Example ExIV3: An aerosol-generating device according to any one of Examples ExIV to ExIV2, wherein each of the mating surfaces is adjacent to and located between two side surfaces on opposite sides of the respective housing portion, wherein two pairs of two side surfaces of the housing portions on opposite sides of the housing portions are flush with each other in the attached state.

Example ExIV4: An aerosol-generating device according to any one of Examples ExIV to ExIV3, wherein each of the mating surfaces is located between two parallel mating surface edges.

Example ExIV5: An aerosol-generating device according to any one of Examples ExIV to ExIV4, wherein one of the male and female mating surfaces comprises a male guide element of a guide mechanism of the device, wherein the other one of the male and female mating surfaces comprises a female guide element of the guide mechanism.

Example ExIV6: An aerosol-generating device according to any one of Examples ExIV to ExIV 5, wherein a height of the male mating surface is within a range from 40% to 100%, preferably from 60% to 98%, in particular from 70% to 85% of the respective housing portion.

Example ExIV7: An aerosol-generating device according to any one of Examples ExIV to ExIV 6, wherein a width of the male mating surface is within a range from 60% to 100%, preferably from 80% to 98%, in particular from 85% to 95% of a width of the respective housing portion.

Example ExIV8: An aerosol-generating device according to any one of Examples ExIV to ExIV 7, wherein 40% to 100%, preferably from 60% to 98%, in particular from 70% to 85% of area of the mating surface extends in parallel to a longitudinal axis of the aerosol-generating device.

### Cushioning Mechanism

Example ExV: An aerosol-generating device according to any one of the preceding Examples, wherein the device comprises a cushioning mechanism configured to cushion the housing portions relative to each other in the attached state.

Example ExV1: An aerosol-generating device according to the preceding Example, wherein at least one of the first and second housing portions comprises a male cushioning element and the other one of the first and second housing portions comprises a female cushioning element, wherein the male and female cushioning elements are mutually engaged with each other in the attached state so as to elastically preload the housing portions relative to each other.

Example ExV1a: An aerosol-generating device according to the preceding Example, wherein at least one of the cushioning elements is removably attached to the respective housing portion.

Example ExV1b: An aerosol-generating device according to any of Examples ExV1 to ExV1a, wherein at least one of the cushioning elements forms or covers a lid for covering an opening of the respective housing portion, in particular an opening for removing a power-supply unit or power-consuming unit from the respective housing portion.

Example ExV1bi: An aerosol-generating device according to the preceding Example, Wherein the lid is attached by a screw mount.

Example ExV1c: An aerosol-generating device according any one of Examples ExV1 to ExV1bi, wherein the male cushioning element is embodied as a snap-fit protrusion configured to snap-fit into a corresponding recess of the female cushioning element.

Example ExV1d: An aerosol-generating device according to any one of Examples ExV1 to ExV1c, wherein the male cushioning element is configured to expand into the female cushioning element upon entering into the attached state of the housing portions.

Example ExV1e: An aerosol-generating device according to any one of Examples ExV1 to ExV1d, wherein each of the male and female cushioning elements is symmetrical with respect to a longitudinal direction and/or a transversal direction of the aerosol-generating device.

Example ExV1f: An aerosol-generating device according to any one of Examples ExV1 to ExV1e, wherein the male cushioning element has a form of a pad, knob or elongated element.

Example ExV1g: An aerosol-generating device according to any one of Examples ExV1 to ExV1f, wherein the male cushioning element and the female cushioning element have the same size.

Example ExV1h: An aerosol-generating device according to any one of Examples ExV1 to ExV1g, wherein the aerosol-generating device comprises multiple cushioning elements.

Example ExV1i: An aerosol-generating device according to any one of Examples ExV1 to ExV1h, wherein male and female cushioning elements engage by a form-fit connection.

Example ExV1j: An aerosol-generating device according to any one of Examples ExV1 to ExV1i, wherein at least one of the male and female cushioning elements comprises an elastic material.

Example ExV1ji: An aerosol-generating device according to the preceding Example, Wherein the elastic material comprises rubber.

Example ExV1k: An aerosol-generating device according to any one of Examples ExV1 to ExV1ji, wherein at least one of the male and female cushioning elements is configured to be displaced by the other one of the male and female cushioning elements prior to entering into engagement.

Example ExV11: An aerosol-generating device according to any one of Examples ExV1 to ExV1k, wherein each of the male and female cushioning elements is provided on the respective mating surface of the respective housing portion.

### Reversible Locking Mechanism

Example ExVI: An aerosol-generating device according to any one of the preceding Examples, wherein the device comprises a reversible locking mechanism configured to reversibly lock the housing portions relative to each other in the attached state of the housing.

Example ExVI1: An aerosol-generating device according to the preceding Example, wherein the reversible locking mechanism configured to be reversibly arranged in any one of a locked state, in which the housing portions are locked relative to each other in the attached state of the housing portions, and an unlocked state, in which the housing portions are unlocked relative to each other.

Example ExVI2: An aerosol-generating device according to any one of the Examples ExVI to ExVI1, wherein the locking mechanism comprises a self-locking mechanism configured to self-lock the housing portions upon entering into the attached state.

Example ExVI3: An aerosol-generating device according to any one of the Examples ExVI to ExVI2, wherein the locking mechanism comprises at least one male locking element provided on one of the first and second housing portions and at least one female locking element provided on the other one of the first and second housing portions.

Example ExVI3a: An aerosol-generating device according to the preceding Example, wherein the male and female locking elements are to configured to mutually engage with each other for locking the housing portions.

Example ExVI3b: An aerosol-generating device according to any one of the Examples ExVI13 to ExVI3a, wherein the male and female locking elements are to configured to disengage from each other for unlocking the housing portions.

Example ExVI3c: An aerosol-generating device according to any one of the Examples ExVI3 to ExVI3b, wherein at least one of the male and female locking elements is mechanically and/or elastically preloaded into an engagement position.

Example ExVI3d: An aerosol-generating device according to any one of the Examples ExVI13 to ExVI3c, wherein the male and female locking elements are configured to engage with each other according to hook-and-eye principle.

Example ExVI3e: An aerosol-generating device according to any one of the Examples ExVI3 to ExVI3d, wherein the male and female locking elements are configured to establish a mechanical and/or electrical connection between the first and second housing portions.

Example ExVI4: An aerosol-generating device according to any one of the Examples ExVI to ExVI3e, wherein the reversible locking mechanism comprises at least one snap fit connection.

Example ExVI4a: An aerosol-generating device according to the preceding Example, wherein the snap fit connection comprises a mechanical retention mechanism for mechanical

Example ExVI4b: An aerosol-generating device according to any one of the Examples ExVI4 to ExVI4a, wherein the snap fit connection comprises electric terminals for electric interconnection of the first and second housing portions.

Example ExVI5: An aerosol-generating device according to any one of the Examples ExVI to ExVI4b, wherein the reversible locking mechanism comprises two snap fit connectors, arranged at opposite ends of the first and second housing portions.

### Actuator for Locking Mechanism

Example ExVII: An aerosol-generating device according to any one of the Examples ExVI to ExVI5, wherein the locking mechanism comprises an actuator, configured to lock or unlock the locking mechanism upon actuation.

Example ExVII1: An aerosol-generating device according to the preceding Example, wherein the actuator comprises a push-button.

Example ExVII2: An aerosol-generating device according to any one of the Examples ExVII to ExVII1, wherein the locking mechanism comprises at least one active locking member provided on one of the first and second housing portions and at least one passive locking member provided on another one of the first and second housing portions, wherein the actuation of the actuator causes the active locking member to move.

Example ExVII2a: An aerosol-generating device according to the preceding Example, wherein the actuation of the actuator causes the active locking member to engage the passive locking member for locking the locking mechanism.

Example ExVII2b: An aerosol-generating device according to any one of the Examples ExVII2 to ExVII2a, wherein the actuation of the actuator causes the active locking member to disengage the passive locking member for unlocking the locking mechanism.

Example ExVII3: An aerosol-generating device according to any one of the Examples ExVII to ExVII2b, wherein the actuation of the actuator requires push/pull/slide/rotation operation by a user.

Example ExVII4: An aerosol-generating device according to any one of the Examples ExVII to ExVII3, wherein the push button is provided on the bottom end or side wall of the device.

Example ExVII4a: An aerosol-generating device according to the preceding Example, wherein the push button forms at least 75% of a surface of the bottom end.

### Closure Mechanism

Example ExVIII: An aerosol-generating device according to any one of the preceding Examples, wherein the device comprises an aerosol-generating article-receiving cavity for receiving an aerosol-generating article, wherein the device further comprises a closure mechanism configured to be selectively arranged in each one of at least two different states, including an open state, in which the aerosol-generating article receiving cavity is at least partially or fully exposed, and a closed state, in which the aerosol-generating article-receiving cavity is fully closed.

Example ExVIII1: An aerosol-generating device according to the preceding Example, wherein the first housing portion comprises the aerosol-generating article-receiving cavity.

Example ExVIII2: An aerosol-generating device according to any one of the Examples ExVIII to ExVIII1, wherein the opening communicates with an aerosol-generating chamber of the aerosol-generating device.

Example ExVIII3: An aerosol-generating device according to any one of the Examples ExVIII to ExVIII2, wherein the opening is positioned at the top end of the device.

Example ExVIII4: An aerosol-generating device according to any one of the Examples ExVIII to ExVIII3, wherein the closure mechanism is configured to be transferred between the open state and the closed state by manual/finger operation, preferably by push/pull operation

Example ExVIII5: An aerosol-generating device according to any one of the Examples ExVIII to ExVIII4, wherein the closure mechanism is removably attached to at least one of the first and second housing portions.

Example ExVIII5a: An aerosol-generating device according to the preceding Example, wherein the closure mechanism is attached to at least one of the first and second housing portions by a bayonet mount.

Example ExVIII5b: An aerosol-generating device according to Examples ExVIII5 to ExVIII5a, wherein the closure mechanism is mechanically and/or magnetically attached to at least one of the first and second housing portions.

Example ExVIII6: An aerosol-generating device according to any one of Examples ExVIII to ExVIII5b, wherein the closure mechanism is attached to a protruding element of the first housing portion protruding towards the second housing portion in the attached state.

Example ExVIII7: An aerosol-generating device according to any one of Examples ExVIII to ExVIII6, wherein the closure mechanism is configured to be arranged in the closed state even in the detached state of the housing portions.

Example ExVIII8: An aerosol-generating device according to any one of Examples ExVIII to ExVIII7, wherein the closure mechanism is mechanically and/or magnetically held in the open state and/or into the closed state.

Example ExVIII9: An aerosol-generating device according to any one of Examples ExVIII to ExVIII8, wherein the closure mechanism is configured to seal the opening in the closed state, preferably in an airtight or hermetical manner.

Example ExVIII10: An aerosol-generating device according to any one of Examples ExVIII to ExVIII9, wherein the closure mechanism comprises an attachment base that is (removably) attached to at least one of the first and second housing portions and a cover that is configured to change its position and/or shape relative to the attachment base for transferring the closure mechanism between the open state and the closed state.

Example ExVIII10a: An aerosol-generating device according to the preceding Example, wherein the closure mechanism comprises a guide for guiding the movement of the cover relative to the attachment base between the open and the closed state.

Example ExVIII10ai: An aerosol-generating device according to the preceding Example, wherein one of the cover and the attachment base comprises a male guide element such as a guide pin, wherein the other one of the cover and the attachment base comprises a female guide element such as a guide pin.

Example ExVIII10b: An aerosol-generating device according to any one of Examples ExVIII10 to ExVIII10ai, wherein the attachment base is removably attached to the protruding element of the first housing portion by screw joint, bayonet joint or other rotatable element.

Example ExVIII10bi: An aerosol-generating device according to the preceding Example, wherein a torque engaging surface of the screw or rotatable element is arranged at a lower/inner surface of the protruding element

Example ExVIII10bii: An aerosol-generating device according to any one of Examples ExVIII 10b to ExVIII10bi, wherein one of the male and female guide elements is provided on the protruding element of the first housing portion.

Example ExVIII10c: An aerosol-generating device according to any one of Examples ExVIII10 to ExVIII10bii, wherein the cover is configured to be moved relative to the attachment base between the open state and the closed state along a linear and/or circular and/or curved path.

Example ExVIII10d: An aerosol-generating device according to any one of Examples ExVIII 10 to ExVIII10c, wherein the attachment base has the shape of a pillar.

Example ExVIII10e: An aerosol-generating device according to any one of Examples ExVIII10 to ExVIII10d, wherein the attachment base is invisible from the outside in the attached state of the housing portions and in the closed state of the closure mechanism.

Example ExVIII10f: An aerosol-generating device according to any one of Examples ExVIII10 to ExVIII10e, wherein the attachment base is attachable to and/or detachable from at least one of the first and second housing portions.

Example ExVIII11: An aerosol-generating device according to any one of Examples ExVIII to ExVIII10f, wherein the closure mechanism is detachable in a detached state of the housing portions.

Example ExVIII12: An aerosol-generating device according to any one of Examples ExVIII to ExVIII11, wherein the device has a closed outer surface in the attached state of the housing portions and the closed state of the closure mechanism.

### Foldable Cover

Example ExIX: The aerosol-generating device according to any one of Examples ExVIII to ExVIII12, wherein the closure mechanism comprises a cover that is configured to change its shape for transferring the closure mechanism between the open state and the closed state.

Example ExIX1: An aerosol-generating device according to the preceding Example, wherein the cover is attached to the second housing portion.

Example ExIX2: An aerosol-generating device according to any one of Examples ExIX to ExIX1, wherein the cover is a foldable cover, which is configured to fold and unfold for transferring the closure mechanism between the open state and the closed state.

Example ExIX3: An aerosol-generating device according to any one of Examples ExIX to ExIX2, wherein the cover is at least partially made from an elastic material.

Example ExIX4: An aerosol-generating device according to any one of Examples ExIX to ExIX3, wherein the cover comprises at least two pivotably/foldably connected segments.

Example ExIX4a: An aerosol-generating device according to the preceding Example, wherein the segments are integrally formed

Example ExIX4b: An aerosol-generating device according to any one of Examples ExIX4 to ExIX4a, wherein the segments are connected by means of a solid joint.

Example ExIX4c: An aerosol-generating device according to any one of Examples ExIX4 to ExIX4b, wherein the segments are configured to angle/abut against each other in the open state.

Example ExIX4d: An aerosol-generating device according to any one of Examples ExIX4 to ExIX4c, wherein the segments are configured to be aligned/flush with each other in the closed state.

Example ExIX4e: An aerosol-generating device according to any one of Examples ExIX4 to ExIX4d, wherein, in the closed state of the closure mechanism, a separation line between the two segments is aligned with a separation line or plane of the housing portions in the attached state.

Example ExIX4f: An aerosol-generating device according to any one of Examples ExIX4 to ExIX4e, wherein, in the closed state of the closure mechanism, a perimeter of each of the segments is aligned with a perimeter of the housing portions.

Example ExIX4g: An aerosol-generating device according to any one of Examples ExIX4 to ExIX4f, wherein one of the segments comprises a protrusion which is configured to enter into the opening in the closed state of the closure mechanism.

Example ExIX4h: An aerosol-generating device according to any one of Examples ExIX4 to ExIX4g, wherein each of the segments is adapted to cover the top end of one of the housing portions in the closed state of the closure mechanism.

Example ExIX4i: An aerosol-generating device according to any one of Examples ExIX4 to ExIX4h, wherein a color and/or material of each of the segments is adapted to a color and/or material of the housing portion covered at its top end by the respective segment in the closed state of the closure mechanism.

Example ExIX5: An aerosol-generating device according to any one of Examples ExIX to ExIX4i, wherein the cover is made from metal and/or plastic.

Example ExIX6: An aerosol-generating device according to any one of Examples ExIX to ExIX5, wherein the cover is made from at least two different materials.

Example ExIX7: An aerosol-generating device according to any one of Examples ExIX to ExIX6, wherein the cover has an elastic body (silicon, or silicon-like body).

Example ExIX8: An aerosol-generating device according to any one of Examples ExIX to ExIX7, wherein the cover comprises a metal or metal-like coating.

Example ExIX8a: An aerosol-generating device according to the preceding Example, wherein the metal coating of the cover extends on an outer surface of the cover to form an end edge that aligns with the outer side edges of the first housing portion.

Example ExIX8b: An aerosol-generating device according to any one of Examples ExIX8 to ExIX8a, wherein the metal coating comprises at least one magnetic material.

Example ExIX8c: An aerosol-generating device according to any one of Examples ExIX8 to ExIX8b, wherein the magnetic material comprises at least one of iron, nickel and cobalt.

### Slidable Cover

Example ExX: An aerosol-generating device according to any one of Examples ExVIII to ExIX8c, wherein the closure mechanism comprises a cover that is movable between the open state and the closed state.

Example ExX1: An aerosol-generating device according to the preceding Example, wherein the cover is attached to the second housing portion.

Example ExX2: An aerosol-generating device according to any one of Examples ExX to ExX1, wherein the cover is configured to slide relative to the housing between the open state and the closed state along a linear and/or circular and/or curved path.

Example ExX3: An aerosol-generating device according to any one of Examples ExX to ExX2, wherein the cover has an oval shape.

Example ExX4: An aerosol-generating device according to any one of Examples ExX to ExX3, wherein the cover has two parallel outer edges.

Example ExX4a: An aerosol-generating device according to the preceding Example, wherein the direction of movement of the cover is parallel to its parallel outer edges.

Example ExX5: An aerosol-generating device according to any one of Examples ExX to ExX4a, wherein the cover has two convexly shaped outer edges on opposite ends thereof.

Example ExX6: An aerosol-generating device according to any one of Examples ExX to ExX5, wherein the direction of movement of the cover is aligned with its main axis.

Example ExX7: An aerosol-generating device according to any one of Examples ExX to ExX6, wherein the cover is movable in a plane perpendicular to a main axis of the device, in particular the longitudinal axis of the device.

Example ExX8: An aerosol-generating device according to any one of Examples ExX to ExX7, wherein the device comprises a guide for guiding the movement of the cover between the open state and the closed state.

Example ExX9: An aerosol-generating device according to any one of Examples ExX to ExX8, wherein at least one of the first and second housing portions defines a frame that partially or fully surrounds the cover in the open state and/or the closed state.

Example ExX9a: An aerosol-generating device according to the preceding Example, wherein the frame partially or fully surrounds the cover in the plane of its extension

Example ExX9b: An aerosol-generating device according to any one of Examples ExX9 to ExX9a, wherein the frame partially or fully surrounds the cover in its direction of movement between the open state and the closed state

Example ExX9c: An aerosol-generating device according to any one of Examples ExX9 to ExX9b, wherein the frame is provided on the protruding element of the first housing portion that laterally protrudes from the main longitudinal body of the first housing portion.

### Electrical Connection

Example ExXI: An aerosol-generating device according to any one of the preceding Examples, wherein the device comprises an electrical connection for electrically connecting the power-supply unit to the power-consuming unit in the attached state of the housing portions, wherein the electrical connection comprises a first electrical contact provided on the first housing portion and a second electrical contact provided on the second housing portion, wherein the first and second electrical contacts are elastically preloaded against each other in the attached state.

Example ExXI1: An aerosol-generating device according to the preceding Example, wherein at least one of the first and second electrical contacts comprises a spring-loaded element.

Example ExXI1a: An aerosol-generating device according to the preceding Example, wherein the spring-loaded element is at least one of a pin or a ball.

Example ExXI1b: An aerosol-generating device according to any one of Examples ExXI1 to ExXI1a, wherein the pin is a pogo pin.

Example ExXI2: An aerosol-generating device according to any one of Examples ExXI to ExXI1b, wherein at least one of the first and second electrical contacts comprises a recess for receiving the spring-loaded element or a terminal.

Example ExXI2a: An aerosol-generating device according to the preceding Example, wherein the terminal is a contact plate.

Example ExXI2b: An aerosol-generating device according to any one of Examples ExXI2 to ExXI2a, wherein the recess comprises a spring-loaded metal tab configured to engage with the pin

Example ExXI3: An aerosol-generating device according to any one of Examples ExXI to ExXI2b, wherein each of the first and second electrical contacts is provided on the respective mating surface of the respective housing portion.

### Charge Indicator/Battery Module Feature

Example ExXII: The aerosol-generating device according to any one of the preceding Examples, wherein the device further comprises a charge indicator indicating a charge amount of the power-supply unit.

Example ExXII1: An aerosol-generating device according to the preceding Example, wherein the charge indicator comprises an electronic display.

Example ExXII1a: An aerosol-generating device according to the preceding Example, wherein the charge indicator display is on the power supply unit

Example ExXII1b: An aerosol-generating device according to any one of Examples ExXII1 to ExXII1a, wherein the electronic display is at least one of a segmented display, a LED display, or a OLED display.

Example ExXII2: An aerosol-generating device according to any one of Examples ExXII to ExXII1b, wherein the charge indicator further comprises a charge indicator activator positioned on one of the first and second housing portions, and configured to activate the charge indicator.

Example ExXII2a: An aerosol-generating device according to the preceding Example, wherein the charge indicator activator is a push-button or a touch display.

Example ExXII2b: An aerosol-generating device according to any one of Examples ExXII2 to ExXII2a, wherein a button to activate the charge indicator display is not visible in the attached state of the housing portions

Example ExXII2c: An aerosol-generating device according to any one of Examples ExXII2 to ExXII2b, wherein a button to activate the charge indicator display is provided on a mating surface of the second housing portion.

Example ExXII3: An aerosol-generating device according to any one of Examples ExXII to ExXII2c, wherein the charge indicator further comprises a controller configured to control the electronic display upon user interaction via the charge indicator activator to show the state of charge of the power-supply unit.

### Replaceable Battery Module

Example ExXIII: An aerosol-generating device according to any one of the preceding Examples, wherein the aerosol-generating device further comprises a replacement battery module configured to be removably attached to the first housing portion instead of the second housing portion, wherein the replacement battery module accommodates a second power-supply unit that is configured to supply power to the power consuming unit in the attached state.

Example ExXIII1: An aerosol-generating device according to the preceding Example, wherein the second power-supply unit has a second electrical charge storage capacity that is different to a storage capacity of the power-supply unit accommodated within the first housing portion.

Example ExXIII2: An aerosol-generating device according to Examples ExXIII to ExXIII1, wherein a ratio of the storage capacity of the first and second power supply units is between 1.5 and 3, preferably between 1.5 and 2.5, in particular between 1.7 and 2.3.

Example ExXIII3: An aerosol-generating device according to Examples ExXIII to ExXIII2, wherein the replacement battery module has identical interfaces for electrical and/or mechanical connection to the first housing portion as compared to the second housing portion.

### Identification Item and Unit

Example ExXIV: An aerosol-generating device according to any one of the preceding Examples, wherein at least one of the first and second housing portions, the power-consuming unit and the power-supply unit comprises an identification item, wherein the device comprises an identification unit for identifying at least one of the first and second housing portions, the power-consuming unit and the power-supply unit by means of the identification item.

Example ExXIV1: An aerosol-generating device according to the preceding Example, wherein the identification item comprises an authenticator key.

Example ExXIV2: An aerosol-generating device according to any one of Examples ExXIV to ExXIV1, wherein the identification item is unique, allowing unique identification of the housing portion or unit equipped with the unique identification item.

Example ExXIV3: An aerosol-generating device according to any one of Examples ExXIV to ExXIV2, wherein the identification unit comprises a communication interface enabling communication between at least two of the first and second housing portions, the power-consuming unit and the power-supply unit for identification.

Example ExXIV3a: An aerosol-generating device according to the preceding Example, wherein the communication interface is at least one of a wireless communication interface or a contact-based interface.

Example ExXIV3b: An aerosol-generating device according to any one of Examples ExXIV3 to ExXIV3a, wherein the identification item is permanently embedded.

Example ExXIV3c: An aerosol-generating device according to any one of Examples ExXIV3 to ExXIV3b, wherein the identification item is at least one of an embedded-SIM (eSIM) or integrated SIM (iSIM)

Example ExXIV3d: An aerosol-generating device according to any one of Examples ExXIV3 to ExXIV3c, wherein the identification item comprises an authentication key.

Example ExXIV4: An aerosol-generating device according to any one of Examples ExXIV to ExXIV3d, wherein the device is configured to admit power supply from the power-supply unit to the power-consuming unit upon successful identification of the power-consuming unit and the power-supply unit.

### Charging Module

Example ExXV: An aerosol-generating device according to any one of the preceding Examples, wherein the aerosol-generating device further comprises a charging module configured to be removably attached to the second housing portion instead of the first housing portion, wherein the charging module is configured to charge the power-supply unit in the attached state.

Example ExXV1: An aerosol-generating device according to the preceding Example, wherein the power-supply unit comprises a rechargeable power supply and a charging circuit positioned within the housing portion accommodating the power-supply unit and configured to control a supply of power received from an external device for recharging the power supply.

Example ExXV2: An aerosol-generating device according to any one of Examples ExXV to ExXV1, wherein the power-supply unit comprises a rechargeable battery.

Example ExXV3: An aerosol-generating device according to any one of Examples ExXV to ExXV2, wherein the battery comprises a lithium-based battery.

Example ExXV4: An aerosol-generating device according to any one of Examples ExXV to ExXV3, wherein the power-supply unit comprises a charging electrical contact positioned on the housing portion accommodating the power-supply unit for receiving a supply of power from an external device for recharging the power supply.

Example ExXV5: An aerosol-generating device according to any one of Examples ExXV to ExXV4, wherein the charging electrical contact comprises the second electrical contact of the electrical connection and/or wherein the charging electrical contact forms part of a USB-A connector, a USB-B connector, a USB-C connector, or a micro-USB connector.

Example ExXV6: An aerosol-generating device according to any one of Examples ExXV to ExXV5, wherein the charging circuit comprises a wireless charging circuit configured to wirelessly receive a supply of power from an external device for recharging the power supply.

Example ExXV7: An aerosol-generating device according to any one of Examples ExXV to ExXV6, wherein the charging module has identical interfaces for electrical and/or mechanical connection to the second housing portion as compared to the first housing portion.

### Assembly Method

Example ExXVI: Method for assembling the aerosol-generating device according to any one of the preceding Examples, comprising the steps of:
Transferring the housing portions from the detached state, in which the housing portions are both electrically and mechanically decoupled, into an intermediate state, in which the housing portions are electrically decoupled from each other and mechanically movably coupled relative to each other; and
Moving the housing portions relative to each other in the intermediate state until entering into the attached state, in which the housing portions are both electrically and mechanically coupled with each other.

### TERMS AND DEFINITIONS

### Aerosol-Generating Device

An aerosol-generating device may be a handheld electrically operated smoking system comprising a (rechargeable) battery, control electronics and a power-consuming unit, in particular an electric heater for heating an aerosol-generating article designed specifically for use with the aerosol-generating device.

### Aerosol-Generating Article

The aerosol-generating article may comprise an aerosol-forming substrate, such as a tobacco rod or a tobacco plug, and the heater contained within the aerosol-generating device may be inserted into or located around the aerosol-forming substrate when the aerosol-generating article is inserted into the aerosol-generating device. In an alternative electrically operated smoking system, the aerosol-generating article may comprise a capsule containing an aerosol-forming substrate, such as loose tobacco.

### Main Axis/Longitudinal Axis

The main axis/main extension direction of the aerosol-generating device, namely the axis/direction in which the aerosol-generating device has its greatest length, may be in a longitudinal axis/direction. A transversal axis/direction may be perpendicular to the longitudinal axis/direction. A circumferential direction may be defined around the longitudinal axis/direction. In an upright orientation of the aerosol-generating device, the longitudinal axis/direction may be a height axis/direction and the transversal axis/direction may be a horizontal axis/direction. Any indications in the following regarding “upper”, “top”, “lower” and “bottom” are with respect to the longitudinal axis/direction being the height axis/direction.

### Power-Consuming Unit

The power-consuming unit may be an energy converter configured to consume power, in particular electric power, and transfer it into another energy media, such as thermal energy. The power-consuming unit may be or comprise an electric heater for heating, such as coils for induction heating, the aerosol-generating article.

### Power Supply Unit

The power supply unit may be a storage device, in particular an electrical power storage device. The power supply unit may comprise one or more (rechargeable or non-chargeable) batteries and may also comprise a battery management system (BMS) for operating the one or more batteries, such as power electronics and/or a controller.

### Housing and Housing Portions

The first housing portion and the second housing portion may together define the housing of the aerosol generating device.

### Cushioning Mechanism

The term “cushioning mechanism” as used herein may designate a unit or element that prevents vibration between the first and second housings. Optionally it has some elastic properties, to preserve some elasticity when pressing the two housing portions together.

### BRIEF DESCRIPTION OF DRAWINGS

Exemplary embodiments of the invention will now be further described with reference to the figures in which:

FIG. 1 shows perspective views of an aerosol-generating device with a sliding attachment mechanism according to a first embodiment of the invention in the attached state of the first and second housing portions, in a closed state (left) and in an open state (right) of a closure mechanism for aerosol-generating article-receiving cavity located on the top end of the housing in the first housing portion;

FIG. 2 shows a perspective view of the aerosol-generating device of FIG. 1 in the detached state of the housing portions;

FIG. 3 shows a first perspective view of the aerosol-generating device of FIG. 1 in an intermediate state, in which the first and second housing portions are mechanically coupled for the sliding engagement and electrically decoupled;

FIG. 4 shows a second perspective view of the aerosol-generating device of FIG. 1 in the intermediate state from a different viewpoint;

FIG. 5 is a perspective view of a bottom end of the second housing portion showing a first variant of electric terminals of the aerosol-generating device;

FIG. 6 is a perspective view of a bottom end of the second housing portion showing a second variant of electric terminals of the aerosol-generating device;

FIG. 7 is a perspective view of a bottom end of the second housing portion showing a first variant of a charge indictor for the aerosol-generating device;

FIG. 8 is a perspective view of a bottom end of the second housing portion showing a second variant of a charge indictor for the aerosol-generating device;

FIG. 9 is a perspective view of a top end of the housing portions in an attached state showing a first variant of a cover member embodied as foldable cap in the closed state of the aerosol-generating device;

FIG. 10 is a perspective view of a top end of the housing portions in an attached state showing the cover member according to the first variant in the open state;

FIG. 11 is a perspective view a top end of the second housing portion showing of the cover member according to the first variant in the detached state of the two housing portions;

FIG. 12 is a cross-sectional view of a top end of the housing portions in an attached state showing the cover member according to the first variant in the closed state;

FIG. 13 shows a perspective view of the aerosol-generating device according to the second embodiment of the invention in the intermediate state, in which the housing portions are mechanically movably coupled by a slidable engagement and electrically decoupled;

FIG. 14 is a perspective view of a second variant of a closure mechanism for the aerosol-generating device according to the second embodiment comprising a slidable cover;

FIG. 15 is a perspective bottom view of the top end of the first housing portion of the aerosol-generating device according to the second embodiment, showing the attachment base of the closure mechanism;

FIG. 16 is a perspective top view of the top end of the housing portions of the aerosol-generating device according to the second embodiment in the attached state, showing the closure mechanism according to the second variant in the closed state;

FIG. 17 is a perspective top view of the top end of the housing portions of the aerosol-generating device according to the second embodiment in the attached state, showing the closure mechanism according to the second variant in the open state;

FIG. 18 is a perspective view of the top end of the first housing portion of the aerosol-generating device according to a third embodiment in the detached state of the housing portions showing a third variant of a closure mechanism comprising as slidable cover provided within a frame;

FIG. 19 is a perspective view of the top end of the aerosol-generating device according to the third embodiment in the attached state of the housing portions with a small-sized second housing portion showing the closure mechanism as shown in FIG. 18 in a closed state;

FIG. 20 shows is a perspective view of the top end of the aerosol-generating device according to the third embodiment in the attached state of the housing portions with a large-sized second housing portion (i.e., third housing portion) showing the closure mechanism as shown in FIG. 18 in a closed state;

FIG. 21 is a schematic and perspective view of the top end of an aerosol-generating device according to a fourth embodiment in the attached state of the housing portions showing a fourth variant of a closure mechanism comprising a slidable cover with a removable attachment base shaped as a carrier disk;

FIG. 22 is a perspective view of an aerosol-generating device according to the second embodiment shown in FIG. 13 in the detached state of the housing portions showing a first variant of a cushioning mechanism;

FIG. 23 is a perspective view of an aerosol-generating device according to the second embodiment shown in FIG. 13 in the detached state of the housing portions showing a second variant of a cushioning mechanism;

FIG. 24 is a perspective view of an aerosol-generating device according to a fifth embodiment of the invention with a press/click locking mechanism;

FIG. 25 shows another perspective view of the aerosol-generating device according to the fifth embodiment in the detached state;

FIG. 26 shows a cross-sectional view of a first locking mechanism of the aerosol-generating device according to the fifth embodiment;

FIG. 27 shows a cross-sectional view of a second locking mechanism of the aerosol-generating device according to the fifth embodiment;

FIG. 28 visualizes an attachment process of the aerosol-generating device according to the fifth embodiment in three steps and views, wherein the housing portions are in a detached state in the left view, wherein the housing portions are in an intermediated state in the center view, and wherein the housing portions are in an attached state in the right view;

FIG. 29 shows a detachment process of the aerosol-generating device according to the fifth embodiment in three steps and views, wherein the housing portions are in the attached state in the left view, wherein the housing portions are in the intermediated state in the center view, and wherein the housing portions are in the detached state in the right view;

FIG. 30 shows a schematic architecture of an identification unit for identifying at least one of the housing portions of the aerosol-generating devices according to one of the embodiments.

### DETAILED DESCRIPTION OF EMBODIMENTS

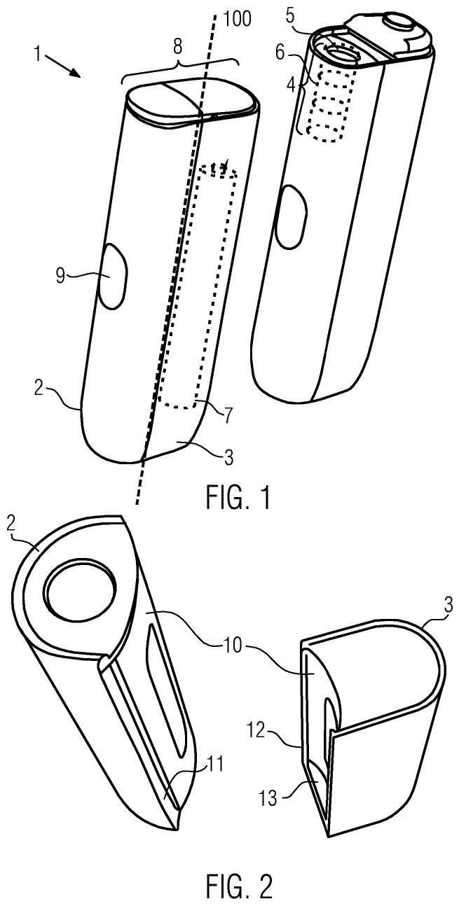

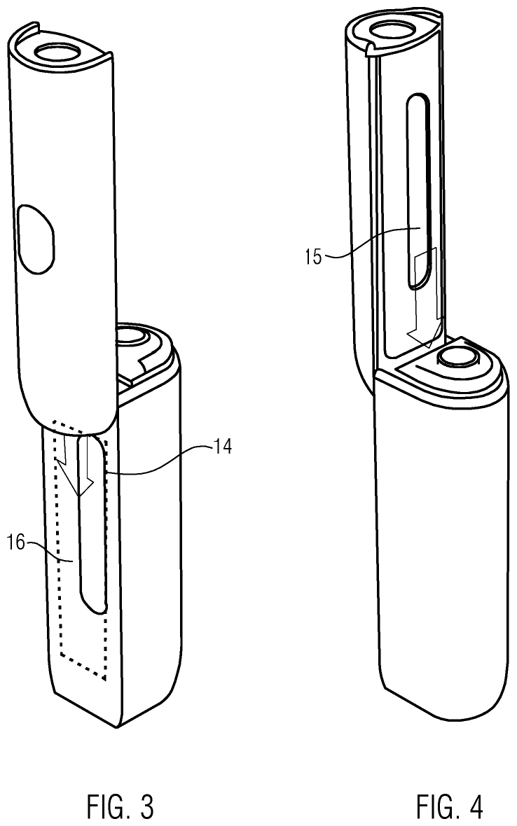

FIGS. 1 to 3 show the aerosol generating device 1 according to a first embodiment in three different states, including the attached state in FIG. 1, the detached state in FIG. 2 as well as the intermediate state in FIG. 3. The other embodiments comprise the same features as the first embodiment and the differences will be described herein.

Referring to FIG. 1, the aerosol generating device 1 comprises two housing portions 2, 3 being reversibly interconnected with each other via a guide mechanism, allowing a sliding movement of the housing portions 2, 3 relative to each other along the longitudinal axis of the device 1.

The first housing portion 2 can accommodate a power consuming unit 4 in form of a tubular coil configured to consume power during operation of the aerosol generating device 1 to generate an aerosol by performing induction heating. In particular, the first housing portion 2 comprises an opening 5 with an aerosol-generating article-receiving cavity in form of a chamber 6 for receiving an aerosol generating article. The chamber 5 is defined by the tubular coil.

The second housing portion 3 accommodates a power supply unit 7. The power supply unit 7 comprises a electrical storage device, in particular a rechargeable battery to supply power to the tubular coil for generating aerosol.

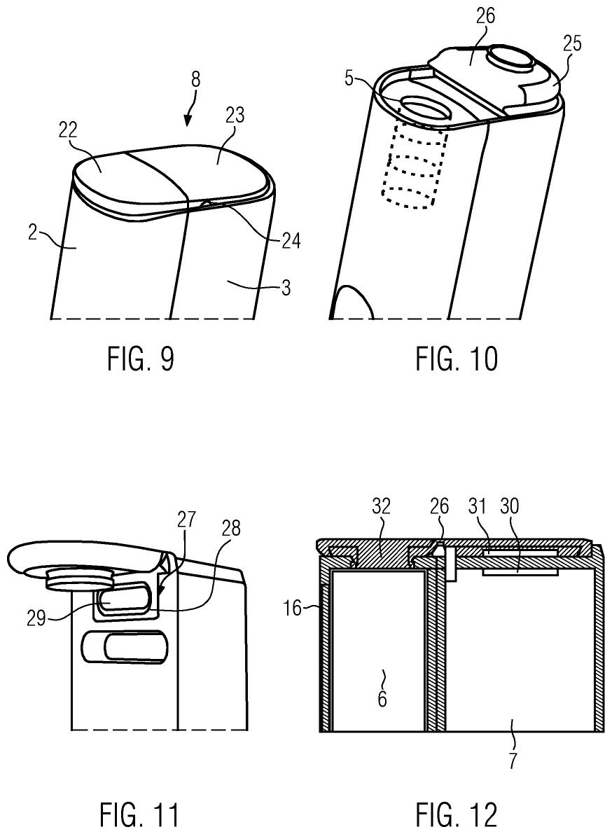

The aerosol generating device 1 further comprises a closure mechanism, in the variant shown in form of a foldable cover 8 for closing the opening 5 of the chamber 6. The structure and function of the foldable cover 8 will be described with reference to FIGS. 9 to 12.

A main activation unit 9 is provided on the first housing portion 2 configured to control operation of the aerosol-generating device 1 upon user interaction, such as a push operation. Element 9 can also be a curved display screen that allows to visually provide information to a user, for example but not limited to a LCD or LED display screen, or a display screen having touch-sensitive properties thereby also configured to operate as an activation unit in combination with the display function. Preferably, the display screen has rounded edges, or is substantially round or oval in shape, and its outer surface curved to match with the curvature of the curved outer surface of the first housing portion 2. Also, preferably, the display screen 9 is arranged substantial in the middle of the first housing portion 2, when viewed along an axis 100. In this respect, housing portion 3 for holding a battery can be such that there is no display screen arranged thereon, to simplify the design of housing portion.

FIG. 2 shows the two housing portions 2, 3 in the detached state. Each of the two housing portions 2,3 comprises a mating surface 10. The mating surface 10 of the first housing portion 2 has a convex shape and is configured to engage with a concave shaped mating surface 10 of the second housing portion 3 that is negative to the convex shape of the first housing portion 2.

A guide mechanism is provided on the edge of the mating surfaces 10 to guide the housing portions 2, 3 relative to each other along the main axis 100 during assembling, in particular in the intermediate state. The guide mechanism includes a guide groove 11 interacting with a guide rail 12 arranged on the facing mating surfaces 10.

A stopper 13 is provided on the mating surface 10 of the second housing portion 3 to stop the guided movement when the two housing portions 2,3 transition from the intermediate state to the attached state. The stopper 13 has the form of a protrusion and is configured to engage with a mating recess of the mating surface 10 of the first housing portion 2.

Referring to FIG. 3, a cushioning mechanism is provided on the mating surfaces 10. The cushioning mechanism comprises a male cushioning element 14 in form of an elongated elastic protrusion element provided on the mating surface 10 of the second housing portion 3 to engage with a female cushioning element 15 in form of a recess provided on the mating surface 10 of the first housing portion 2 so as to preload the housing portions 2, 3 relative to each other in the attached state of the housing portions 2, 3.

A power supply lid 16 is provided on the mating surface 10 of the second housing portion 3 enabling the power supply unit 7 or a battery accommodated within the second housing portion 3 to be replaced, to remove battery from a battery compartment that can be embedded or arranged in housing portion 3. With the interconnection of housing portions 3, 4, lid 16 can be concealed, and also its inadvertent removal can be prevented.

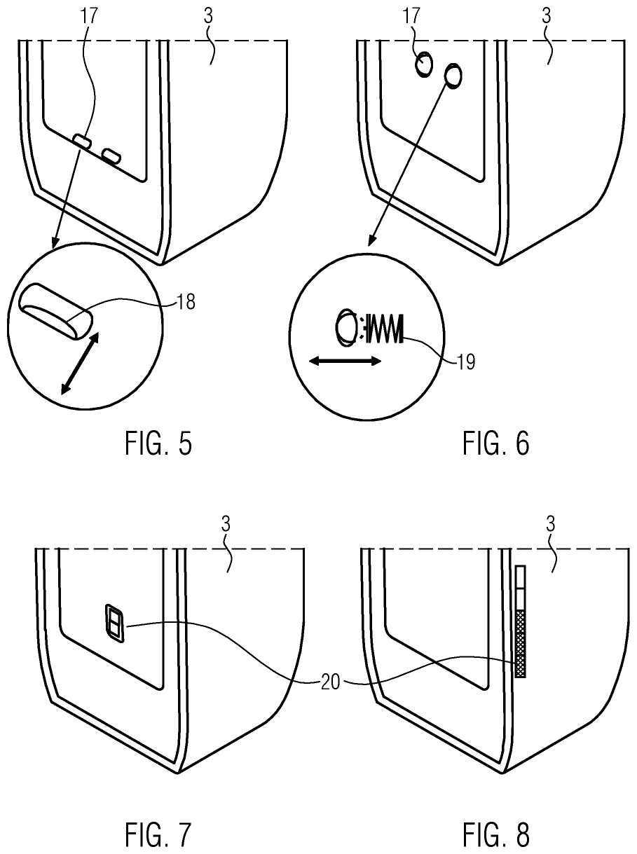

FIGS. 5 and 6 depict male electric terminals as parts of an electrical connection mechanism for electrically connecting the housing portions 2, 3, in particular, electrically connecting the power supply unit 7 to the power consuming unit 4. The electrical connection mechanism comprises male electric terminals as a first electrical contact 17 and female electric terminals as a second electrical contact (not shown) that are elastically loaded against each other in the attached state of the housing portions 2, 3.

In FIG. 5, the first electrical contact 17 is formed as a spring loaded tab 18 that is configured to be integrated into a recess to press the second electrical contact in the form of a pin against the walls of the recess where the pin is received.

In FIG. 6, the first electrical contact 17 is formed as a spring loaded ball 19 for mating with the second electrical contact in form of a matching recess to provide an electric connection in the attached state of the housing portions 2, 3.

FIGS. 7 and 8 show a charge indicator 20 indicating the charge amount of the power supply unit 7/battery. The charge indicator 20 is positioned on the second housing portion 3, in particular on the mating surface 10 of the second housing portion 3 as shown in FIG. 7 so that the charge indicator 20 is not visible in the attached state.

The charge indicator 20 may be embodied as a segmented display, in particular a seven-segment display, as shown in FIG. 7.

In FIG. 8, the charge indicator 20 is provided on an exterior surface of the second housing portion 3. The charge indicator 20 may comprise several LEDs persistent in a row wherein each LED represents a predefined charge amount.

Preferably, the charge indicator 20 is provided on the second housing portion 3, in particular integrated into a button (not shown) to activate the charge indicator 20. Preferably the charge indicator 20 as well as the button are provided on the mating surface 10, so that it is not visible in the attached state of the housing. In this way, the exterior design remains minimalist. Also, this allows the user to rapidly check the battery status by pressing the button before attaching the housing portions 2, 3, for example in cases the user might have several second housing portions 3 at hand (cf. FIGS. 19 and 20).

FIGS. 9 to 12 show detailed perspective views of a closure mechanism with a foldable cover 8 implemented in the aerosol-generating device 1 according to FIG. 1.

FIG. 9 shows the foldable cover 8 in a closed position.

FIG. 10 shows the foldable cover 8 in an opened position.

As shown in FIGS. 9 and 10, the foldable cover 8 comprises two segments 22, 23 embodied in a single piece and forming a solid joint. The segments 22, 23 are divided by a predetermined bend edge 24 in form of an elongated recess provided on the bottom of the foldable cover 8 to facilitate folding (open/close) operations carried out by a user. The second segment 23 is attached to the second housing portion 3 and the first segment 22 is pivotably connected to the to the second segment 23 so to close or open the opening 5 of the chamber 6, thereby changing its shape.

The foldable cover 8 comprises two layers 25, 26. The second layer 26 is formed from elastic material which is coated with a metal coating (building the first layer 25) on top of the elastic material, so that only the metal coating is visible in the closed state. Preferably, the color of the metal coating corresponds to the color of the metal or metal coating of the respective housing portions 2,3.

Referring now to FIG. 11, the foldable cover 8 further comprises a tongue 27 to removably attach the cover 8 to the second housing portion 3. In particular, tongue 27 comprises a tongue recess 28 to engage with a mating housing-side protrusion 29 on the mating surface 10 of the second housing portion 3.

FIG. 12 shows a cross sectional view of an upper portion of the aerosol-generating device 1 according to FIG. 1. A first magnetic element 30 in the form of a plate is integrated into the second housing portion 3 and is configured to engage with a second magnetic element 31 integrated into the foldable cover 8, in particular the second segment 23 of the foldable cover to hold/fix the cover on the second housing portion 3. Moreover, the first segment 22 of the cover 8 includes a coin-shaped magnetic element 32 configured to engage with the first magnetic element 30 and/or the second magnetic element 31 so to hold the foldable cover 8 in the open position.

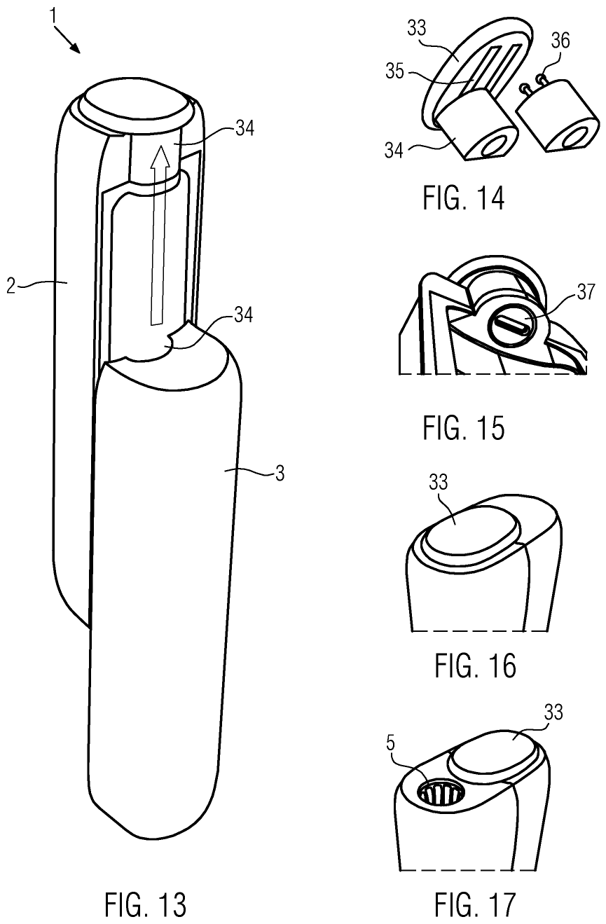

FIGS. 13 to 17 show a detailed perspective view of the closure mechanism comprising a movable (slidable) cover 33 is, which may be used in the aerosol-generating device 1 according to FIG. 1.

As can be seen from FIG. 13, the movable cover 33 is provided on top of the first housing portion 2 and is attached to the first housing portion 2 with its attachment base embodied as a protruding element 34 in the exemplary form of a half cylinder. With this arrangement, the user can close the chamber 6 with cover 33, even when the second housing portion 3 is removed from the first housing portion 2. A cavity 34′ for receiving the protruding element 34 is provided on the second housing portion 3. The cavity 34′ has a complementary shape to protruding element 34 and is sized to not interfere with the slidable engagement, i.e., the movable cover 33 during its movement.

The attachment base (protruding element) 34 is arranged on or on top of the mating surface 10, so as to be invisible in the attached state of the housing portions 2, 3. The attachment base (protruding element) 34 engages with the cover 33 via a guide mechanism. In particular, the cover 33 is provided with guide slots 35 that engage with guide pins 36 provided on the top end of the attachment base (protruding element) 34 so that the cover 33 is movable/slidable relative to the attachment base between the closed and open position. The attachment base (protruding element) 34 is removably mounted on the first housing portion 2 via a mount 37, such as a screw mount as shown in FIG. 15. FIG. 16 shows the movable cover 33 in the closed position.

In FIG. 17 shows the movable cover 33 in the opened position.

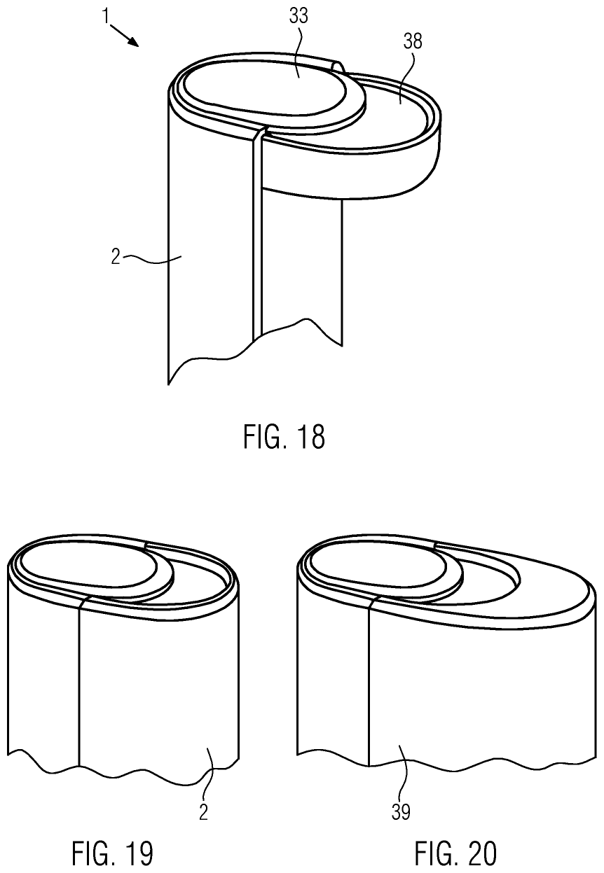

FIGS. 18 to 20 depict an alternative to the closure mechanism of FIGS. 13 to 17. The closure mechanism comprises a frame 38 on top of the attachment base (protruding element) that laterally protrudes from the first housing portion 2. The frame 38 fully surrounds the movable cover 33 in its plane of extension and movement between the opened position and the closed position. A cavity for receiving the protruding element comprising the frame 38 is provided on the second housing portion 3. The cavity has a complementary shape to the protruding element comprising frame 38 and is sized to not interfere with the movable cover 33 during its movement.

All the cover variants of FIGS. 13 to 20 provide for one or more of the following benefits:
Removability of the cover so that it can be replaced with a new one, for example, for customization or to replace an old defective one,
Integration of the cover to the first housing portion 2 (having the power-consuming unit 4) so that the power supply unit 7 (battery) can be removed and at the same time the opening 5 can be closed, and
Aesthetic integration of the cover to the two-housing design, especially with the metallic coating adapted to match with the color/metal/metal coating of the housing portions.

As indicated in FIGS. 19 and 20, the second housing portion 3 may be exchangeable. In particular, multiple different second housing portions 3 of different sizes with a battery of different energy storage capacities are provided and are suitable to engage with the first housing portion 2. For example, the second housing portion 3 shown in FIG. 19 is smaller than the second housing potion (also named third housing portion 39 herein) of FIG. 20. A user can therefore decide whether to have a small-sized second housing portion 3 with less energy storage capacity or a larger-sized one with more storage capacity.

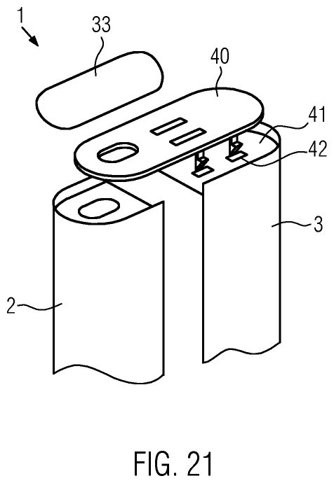

Another variant of the closure mechanism is shown in FIG. 21, where the movable cover 33 is placed on a removable attachment base in form or a carrier disk 40 or plate that is placed onto the upper side surface of both the first housing portion 2 and the second housing portion 3 by a removable attachment mechanism, for example, by clips 41 that can engage with corresponding openings or cavities 42. The attachment base (carrier disk 40 or plate) has an access opening 43 that corresponds to the opening 5 for the aerosol-generating article and can slidably hold the movable cover 33 for opening and closing the opening. This feature allows for a removable and replaceable cover 33 and plate design.

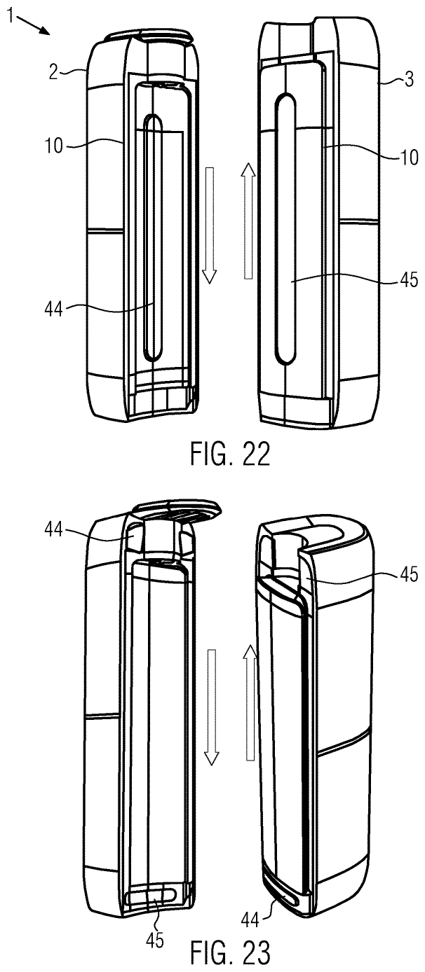

A cushioning mechanism configured to cushion the housing portions 2, 3 relative to each other in the attached state is shown in FIGS. 22 and 23.

In FIG. 22, an male cushioning element 44 in form of an elongated elastic element, e.g. made from rubber, is provided on the mating surface 10 of the first housing portion 2 and mainly extends along the main axis 100. The mating surface 10 of the second housing portion 2 comprises a female cushioning element 45 in form of a recess to mutually engage with the elastic element in the attached state of the housing so as to elastically preload the housing portions 2, 3 relative to each other. The male cushioning element 44 and the female cushioning element 45 are embodied as a snap-fit connection.

In another variant as shown in FIG. 23 the cushioning elements 44, 45 are provided on both the lower portion of the housing and the upper portion of the housing.

In other variants, the upper cushioning elements 44, 45 can form a mechanical retention mechanism as well forming electric terminals/connectors for electric interconnection (cf. FIGS. 5 and 6) of the housing portions 2, 3, thereby combining two features in one. In this respect, there can be two snap fit connectors, arranged adjacent to the protruding element 34, as shown in FIG. 23. This arrangement at the top of the first housing portion 2 also allows for a snap fit engagement at the end of the sliding movement with respect to the two housing portions 2, 3. Also, due to the protruding element 34 located between the two terminals, an accidental short circuit can be prevented, for example, if the user places the first housing portion 2 on a metallic surface. The terminals of the first housing portion 2 accommodating the power consuming unit 4 are the male/protruding ones, whereas the ones on the second housing portion 3 having the power supply unit 7 should be the female/recessed ones, as there is the cavity between the two interconnection terminals. This function could be reversed, so that the electric terminals/snap fit interconnection is formed at the bottom, or a combination of top and bottom.

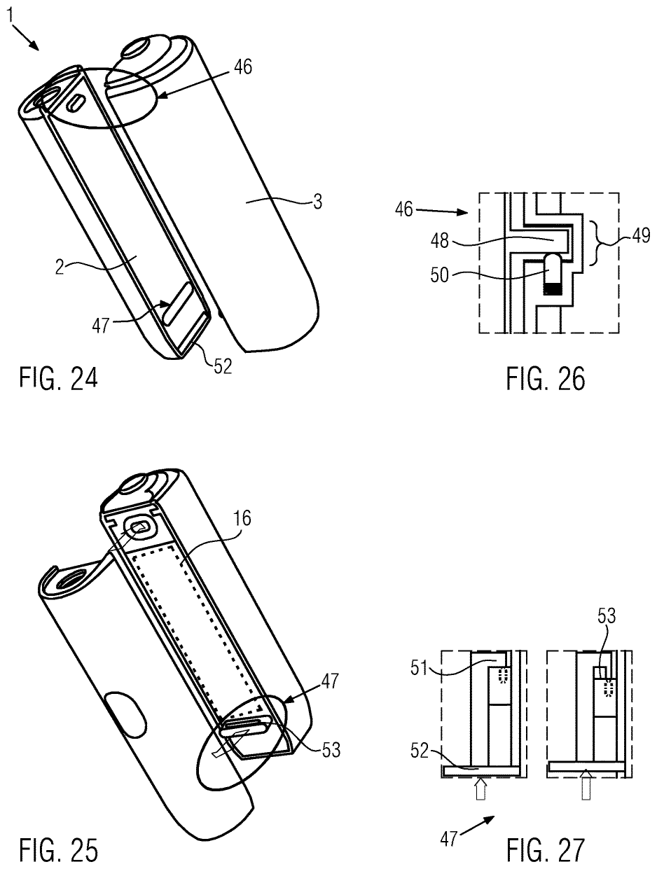

FIGS. 24 to 29 show another variant of an aerosol-generating device 1 where the housing portions are attached by a press/click locking mechanism instead of the slidable mechanism shown in FIGS. 1 to 3. FIGS. 24 and 25 show different perspective views of the two housing portions 2, 3 in the detached state.

FIG. 26 shows a cross-sectional view of a first locking mechanism 46 that is provided on the upper portion of housing portions 2, 3.

FIG. 27 shows a cross-sectional view of a second looking mechanism 47 that is provided on the lower portion of the housing portions 2, 3. Both, the first and second locking mechanisms 46, 47 function according to the hook-and-eye principle, while the first locking mechanism 46 is embodied as a passive locking mechanism and the second locking mechanism 47 is embodied as an active locking mechanism.

The first locking mechanism 46 comprises a hook 48 on the first housing portion 2 and a recess (eye) 49 with a spring-loaded pin 50 on the second housing portion 3 configured to engage with the hook 48 in the attached state.

The second locking mechanism 47 comprises a hook 51 that is connected to an actuator 52 in form of a push-button provided on the bottom of the first housing portion 2 to form an active locking member. A pin 53 with a recess for the hook 51 is provided on the second housing portion 3 to lock the housing portions 3, 4 relative to each other in the attached state.

A power supply lid 16 is provided on the mating surface 10 of the second housing portion 3 enabling the power supply unit 7 or a battery accommodated within the second housing portion 3 to be replaced.

In FIG. 28, an example assembling process to attach the housing portions 2, 3 of the aerosol generating device 1 of FIGS. 24 to 27 is depicted. In a first step, the housing portions 2, 3 are in a detached state without electrical or mechanical connection. Subsequently, a user brings the housing portions 2, 3 into an intermediate state, in which the housing portions 2, 3 are mechanically and movably coupled but still electrically decoupled, by bringing the male and female locking elements of the first locking mechanism 46 into engagement, thereby defining a fulcrum 54. Next, in the intermediate state, the user pivots the first housing portion 2 relative to the second housing portion 3 around the fulcrum 54 until the housing portions 2, 3 enter into the attached state, in which the housing portions 2, 3 are mechanically and electrically coupled, wherein the male and female locking elements of the second locking mechanism 47 enter into engagement and self-lock the housing portions 2, 3 in the attached state with an accompanying click noise. Electrical and mechanical connection between the housing portions 2, 3 may be established by the same elements or by different elements

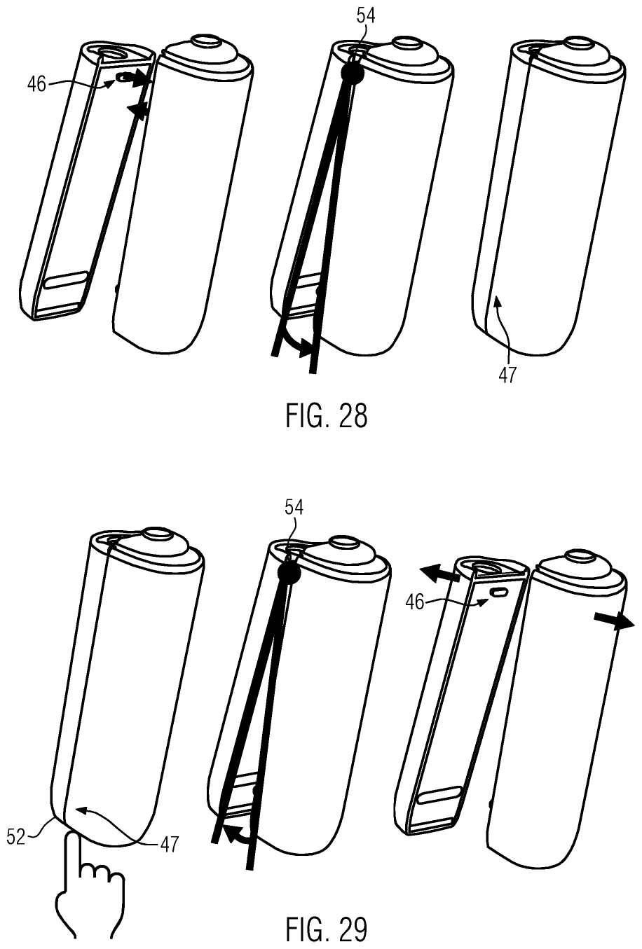

To detach the housing portions 2, 3 from each other, as shown in FIG. 29, the user first presses/pushes the actuator 52 on the bottom of the first housing portion 2 to unlock the second locking mechanism 47 and to transfer the housing portions 2, 3 from the attached state to the intermediate state. In a next step, the user pivots the second housing portion 3 relative to the first housing portion 2 around the fulcrum 54. At a predefined angle, the hook 48 of the first locking mechanism 46 pushes the spring-loaded pin 50 of the first locking mechanism 46 downwards thereby enabling detachment of the first housing portion 2 from the second housing portion 3, thus transferring the housing portions 2, 3 from the intermediate state to the detached state.

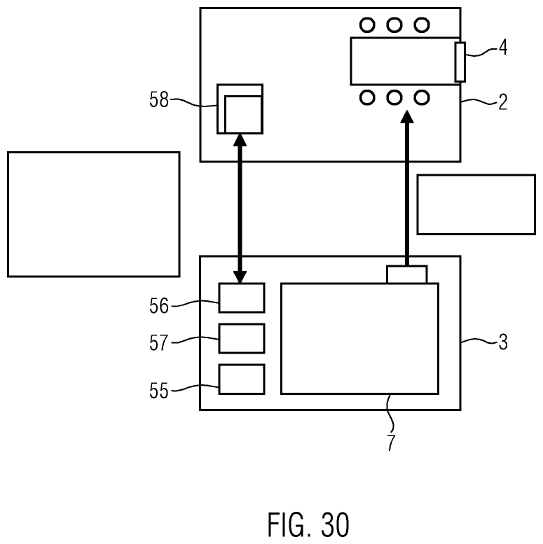

FIG. 30 shows a schematic architecture of an identification unit of the aerosol-generating device 1 for identifying the second housing portion 3 having the power supply unit 7 by means of the identification item.

Every second housing portion 3 can be equipped with an identification item, including a SIM 55 or device (subscriber identity module), for example a software-based eSIM card or SIM card/chip (micro-SIM or nano-SIMI) that can communicate via a data communication interface with a data processor 58 associated with the power consuming unit 4 in the first housing portion 2 in the attached state of the housing. This can be done directly by communicating with an I/O interface 56 of the SIM, or via an additional data processor 57 on the second housing portion 3. The SIM 55 includes a secret and optionally unique Ki encryption key that cannot be read from the outside of the SIM 55 that can be initially recorded by the manufacturer in a database for authenticating original second housing portions 3. Typically, the secret key Ki has a 128 bit value. For example, each secret key Ki can be previously recorded in the database and can be (uniquely) associated with an authorized second housing portion 3. Thereby, the/second housing portion 3 can be checked to see if it is an original or a copy, providing for a technical authenticity protection. Other data from the SIM 55 could also be used for authentication (other than the secret key Ki), for example but not limited to ICCID, IMSI, IMEI, MSISDN, and/or EID. The SIM 55 itself can also generate session keys from the secret Ki key, with the data processor that is internal to the SIM, so that the secret Ki key never leaves the electronics of the second housing portion 3, more specifically the inner storage memory for the secret key of the SIM 55. The power consuming unit 4 applies the same encryption/decryption algorithm to authenticate the second housing portion 3.

In a simplified variant, to avoid managing many different secret keys for each and every second housing portions 3, the second housing portion 3 can be equipped with a digital circuit (not necessarily a SIM) having a secretly stored key among a certain limited number of secret keys, or just one secret key for all second housing portions 3, and the power consuming unit 4/first housing portion 2 can request authentication of the second housing portion 3 based on the limited number of secret keys, or just the one secret key. For example, it is possible to use one and the same secret key for the second housing portions 3 (or a limited number thereof), and then run an encryption algorithm to generate session keys for each algorithm. The power consuming unit 4/first housing portion 2 could have the same secret key stored therein (for example in a way that it cannot be read from the outside), and employ the same algorithm to authenticate the second housing portion 3 with the session keys. This would allow to imitate the SIM 55 functionality with a limited complexity. In this respect, it is also possible that eSIM architecture is used, but using only using a limited number of keys, for example such that not every second housing portion 3 has its unique and secret key Ki, but a certain limited number, or even just one secret key Ki. Such a solution provides for less authentication security, but is much easier to manage, and could be sufficient for authenticating second housing portion 3 for an aerosol generating device 1.

Once the power consuming unit 4 has authenticated the second housing portion 3, it would be possible to start or allow for aerosol formation by the power consuming unit 4, for example to enable heat generation by the power consuming unit 4. If the second housing portion 3 could not be authenticated, error information could be generated, for example a visual, audible, or haptic signal or a combination thereof, and the power consuming unit 4 could be disabled.

It is technically also possible that the SIM 55 or equivalent circuit is integrated into the first housing portion 2 or module to authenticate the first housing portion 2 before allowing the power consuming unit 4 to operate.

While the data communication can be done via a separate data communication channel between the housing portions 2, 3, it can also be done over the electrical connection mechanism shown in FIGS. 5 and 6, thereby only have two electrical contacts and no specific data communication terminals or interconnections. It is also possible that the data communication for authentication is done via a wireless interface, for example Bluetooth or an RFID circuit.

In addition the first housing portion 2 and the second housing portion 3 can be paired, for example with a pairing process that is for example performed by the first housing portion 2, thereby allowing to use unique keys for each second housing portion 3, without actually having to manage all the secret keys in a database. For example, upon first interconnection of a new or other original second housing portion 3 with the first housing portion 2, the second housing portion 3 can request pairing, with a pairing algorithm. But it is also possible that the pairing is done at manufacturing level, and not with the end user.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein.

REFERENCE SIGNS LIST
1. aerosol-generating device
2. first housing portion
3. second housing portion
4. power consuming unit (tubular coil)
5. opening
6. chamber (aerosol-generating article receiving cavity)
7. power supply unit (battery)
8. foldable cover/cap
9. main activation unit
10. mating surface(s) of first housing portion 2 and second housing portion 3
11. guide groove (guide mechanism)
12. guide rail (guide mechanism)
13. stopper
14. male cushioning element (cushioning mechanism)
15. female cushioning element (cushioning mechanism)
16. power supply lid
17. first electrical contact (electrical connection mechanism)
18. spring loaded tab
19. spring loaded ball
20. charge indicator
21. segment display
22. first segment of cover 8
23. second segment of cover 8
24. predetermined bend edge of cover 8
25. first layer (metal coating) of cover 8
26. second layer (elastic material) of cover 8
27. tongue
28. tongue recess
29. housing-side protrusion
30. first magnetic element
31. second magnetic element
32. coin-shaped magnetic element
33. moveable cover/cap
34. protruding element/34′. cavity for protruding element 34
35. guide slots
36. guide pins
37. mount
38. frame
39. third housing portion
40. carrier disk
41. clips
42. cavity for clips 41
43. access opening
44. male cushioning element
45. female cushioning element
46. first locking mechanism
47. second locking mechanism
48. hook of first locking mechanism
49. eye of first locking mechanism
50. spring-loaded pin
51. hook of second locking mechanism
52. actuator (pushable release button)
53. pin with recess (eye) for hook 51 of second locking mechanism
54. fulcrum
55. SIM (identification item)
56. I/O interface
57. processor of power supply unit 7/second housing portion 3
58. processor of power consuming unit 4/first housing portion 2
100. main (longitudinal) axis

1.-15. (canceled)

16. An aerosol-generating device, comprising:
a first housing portion and a second housing portion, the first and the second housing portions being reversibly interconnectable and configured to be selectively arranged in any one of at least two different states, including an attached state, in which the first and the second housing portions are attached to each other, and a detached state, in which the first and the second housing portions are detached from each other;
a power-consuming unit configured to consume power during operation of the aerosol-generating device to generate an aerosol;
a power-supply unit configured to supply power to the power-consuming unit in the attached state of the housing portions,
wherein the first housing portion includes the power-consuming unit, and
wherein the second housing portion includes the power-supply unit; and
a cushioning mechanism configured to cushion the first and the second housing portions relative to each other in the attached state,
wherein at least one of the first and the second housing portions comprises a male cushioning element and the other one of the first and the second housing portions comprises a female cushioning element,
wherein the male and the female cushioning elements are mutually engaged with each other in the attached state so as to elastically preload the first and the second housing portions relative to each other,
wherein the male cushioning element has a form of a pad, knob, or elongated element,
wherein the male cushioning element comprises an elastic material, and
wherein the elastic material comprises rubber.

17. The aerosol-generating device according to claim 16, wherein the first and the second housing portions are configured to be selectively arranged in any one of at least three different states, including the attached state, the detached state, and an intermediate state, in which the first and the second housing portions are mechanically movably coupled relative to each other and electrically decoupled from each other.

18. The aerosol-generating device according to claim 16, further comprising a guide mechanism configured to guide a movement of the first and the second housing portions relative to each other.

19. The aerosol-generating device according to claim 16, wherein each of the first and the second housing portions comprises at least one mating surface configured to mutually face and/or engage with each other in attached state.

20. The aerosol-generating device according to claim 16, further comprising a reversible locking mechanism configured to reversibly lock the first and the second housing portions relative to each other in the attached state of a housing.

21. The aerosol-generating device according to claim 20, wherein the reversible locking mechanism comprises an actuator configured to lock or unlock the reversible locking mechanism upon actuation.

22. The aerosol-generating device according to claim 16, further comprising:
an aerosol-generating article-receiving cavity configured to receive an aerosol-generating article; and
a closure mechanism configured to be selectively arranged in each one of at least two different states, including an open state, in which the aerosol-generating article-receiving cavity is at least partially or fully exposed, and a closed state, in which the aerosol-generating article-receiving cavity is fully closed.

23. The aerosol-generating device according to claim 22, wherein the closure mechanism comprises a foldable cover that is configured to fold and unfold for transferring the closure mechanism between the open state and the closed state.

24. The aerosol-generating device according to claim 22, wherein the closure mechanism comprises a cover that is movable between the open state and the closed state.

25. The aerosol-generating device according to claim 16,
further comprising an electrical connection configured to electrically connect the power-supply unit to the power-consuming unit in the attached state of the first and the second housing portions,
wherein the electrical connection comprises a first electrical contact provided on the first housing portion and a second electrical contact provided on the second housing portion, and
wherein the first and the second electrical contacts are elastically preloaded against each other in the attached state.

26. The aerosol-generating device according to claim 16, further comprising a charge indicator indicating a charge amount of the power-supply unit.

27. The aerosol-generating device according to claim 16,
wherein at least one of the first and the second housing portions, the power-consuming unit, and the power-supply unit comprises an identification item, and
wherein the aerosol-generating device further comprises an identification unit configured to identify at least one of the first and the second housing portions, the power-consuming unit, and the power-supply unit by means of the identification item.

28. The aerosol-generating device according to claim 16,
further comprising a charging module configured to be removably attached to the second housing portion instead of the first housing portion,
wherein the charging module is configured to charge the power-supply unit in the attached state.

29. A method for assembling the aerosol-generating device according to claim 16, the method comprising the steps of:
a. transferring the first and the second housing portions from the detached state, in which the first and the second housing portions are both electrically and mechanically decoupled, into an intermediate state, in which the first and the second housing portions are electrically decoupled from each other and mechanically movably coupled relative to each other; and
b. moving the first and the second housing portions relative to each other in the intermediate state until entering into the attached state, in which the first and the second housing portions are both electrically and mechanically coupled with each other.
